(19) United States
(12) Patent Application Publication
(10) Pub. No.: US 2025/0156941 A1
(43) Pub. Date: May 15, 2025

(54) Technologies for Prediction of Recurring Transactions

(71) Applicant: The PNC Financial Services Group, Inc., Pittsburgh, PA (US)

(72) Inventors: Jacob Harold Schoifet, New York, NY (US); Amanda McCracken, Westerville, OH (US); Aaron Michael Chumsky, Pittsburgh, PA (US); Kathryn Joy Barthelmess, Pittsburgh, PA (US); Eric Romantino, Pittsburgh, PA (US); Yating Tian, Foster City, CA (US)

(21) Appl. No.: 18/939,976

(22) Filed: Nov. 7, 2024

Related U.S. Application Data
(60) Provisional application No. 63/598,580, filed on Nov. 14, 2023.

(51) Int. Cl. G06Q 40/02

(52) U.S. Cl. CPC G06Q 40/02

(57) ABSTRACT

Technologies for predicting recurring transactions include a compute device. The compute device includes circuitry configured to obtain data indicative of financial transactions associated with one or more customer accounts with a financial institution. The circuitry may also be configured to perform at least one data transformation operation on descriptions of the financial transactions in the obtained data to enable identification of recurring transactions, including grouping the financial transactions based on a similarity of the descriptions. Additionally, the circuitry may be configured to combine determinations from multiple analysis algorithms executed on a group of the financial transactions to obtain a confidence score indicative of whether the group of transactions represents a recurring transaction, and present, in response to a determination that the confidence score indicates that the group of financial transactions represents a recurring transaction, a predicted amount and date for a recurrence of the recurring transaction.

### RELATED APPLICATIONS

This application claims the benefit of U.S. Provisional Application No. 63/598,580 filed Nov. 14, 2023 for “Technologies for Prediction of Recurring Transactions,” which is hereby incorporated by reference in its entirety.

### BACKGROUND

A problem often encountered by customers of a financial institution is overdrafting of their financial account. That is, when a payment to a payee drawn from the customer's account exceeds the available balance in the account, an overdraft occurs. Overdrafts are problematic both for the financial institution, which must determine how to respond to the overdraft given the lack of funds in the financial account, and for the customer, who may be fined to cover the administrative burden incurred by the overdraft or who may lose the financial account (e.g., have the financial account closed by the financial institution) if the financial account is routinely overdrafted. While a customer may reduce the likelihood of overdrafts by maintaining excess funds in the financial account, such an approach may be inefficient as the money could otherwise be allocated to an alternative financial account with a higher interest rate. Further, existing systems for predicting upcoming transactions may be rendered ineffective when noise is present in the descriptions of transactions associated with the customer financial account or the transactions do not occur with a clear periodicity.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for predicting recurring transactions;

FIG. 2 is a simplified block diagram of at least one embodiment of a compute device of the system of FIG. 1;

FIGS. 3-7 are simplified block diagrams of at least one embodiment of a method for predicting recurring transactions that may be performed by the system of FIG. 1;

FIGS. 8 and 9 are diagrams of user interfaces that may be produced by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

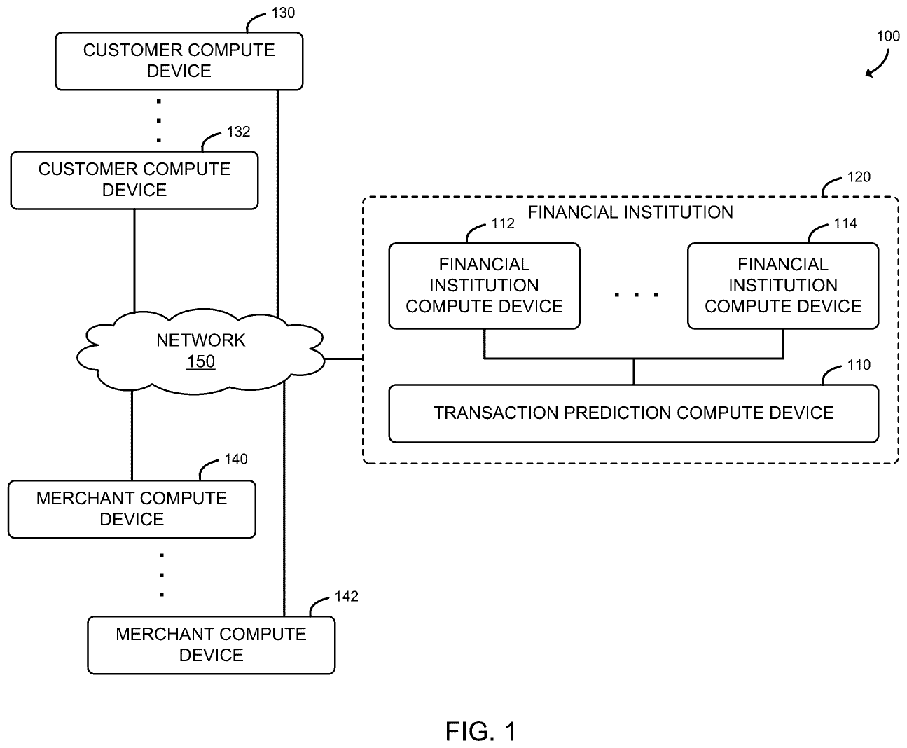

Referring now to FIG. 1, a system 100 for predicting recurring transactions includes, in the illustrative embodiment, a transaction prediction compute device 110 that is communicatively connected to a set of financial institution compute devices 112, 114. The financial institution compute devices 112, 114 process financial transactions (e.g., expenses or related transactions that reduce the account balance and/or deposits or related transactions that increase the account balance) on behalf of account holders (e.g., customers) of a financial institution 120 (e.g., a bank). The compute devices 110, 112, 114 may be located in a data center (e.g., a facility housing compute devices, thermal control equipment, power management equipment, and networking equipment to support the operations of the compute devices). A set of customer compute devices 130, 132 operated by people having financial accounts with the financial institution 120 (e.g., checking accounts) may communicate with merchant compute devices 140, 142 to purchase goods or services from the corresponding merchants (e.g., payees). Data indicative of those purchases (e.g., descriptions, amounts, etc.) is submitted to the financial institution 120 for processing (e.g., to transfer the corresponding amounts of money from the customer's financial account to financial accounts of the corresponding merchants (payees)).

In some cases, the customer may agree to a recurring payment, such as a subscription, to continually receive goods or services from a corresponding merchant. For example, the customer may agree to a monthly fee for cellular phone service, a movie streaming service, a gym membership, recurring delivery of groceries, or the like. In operation, the transaction prediction compute device 110 analyzes data indicative of the transactions processed in connection with a customer's financial account and detects recurring transactions using a complex set of algorithms. As compared to known prediction algorithms that are reliant on a predefined set of key words and strict periodicity rules and that often miss recurring transactions in real world scenarios, the transaction prediction compute device 110 utilizes a series of preprocessing operations that remove noise (e.g., characters, numbers, symbols, or other data that obfuscates the nature and/or reason for a transaction) from the descriptions of the transactions and additionally executes a combination of scoring algorithms that account for irregularities in the periodicity of the transactions. The scoring algorithms are tuned to operate on real-world data but, advantageously, are not reliant on the existence of a large data set for training and configuration. As compared to known systems, the transaction prediction compute device 110 is significantly more reliable at detecting the existence of recurring transactions and in predicting the date and amount of the next recurring transaction. Furthermore, to reduce the likelihood of a customer's account being overdrawn, the transaction prediction compute device 110 informs the customer (e.g., through a user interface) of upcoming recurring transactions, including their predicted date and amount.

While a single transaction prediction compute device 110, two financial institution compute devices 112, 114, two customer compute devices 130, 132, and two merchant compute devices 140, 142 are shown for simplicity and clarity, it should be understood that the number of compute devices, in practice, may range in the tens, hundreds, thousands, or more. Likewise, it should be understood that the compute devices 110, 112, 114, 130, 132, 140, 142 may be distributed differently or perform different roles than the configuration shown in FIG. 1. Further, though shown as separate compute devices 110, 112, 114, 130, 132, 140, 142 in some embodiments, the functionality of one or more of the compute devices 110, 112, 114, 130, 132, 140, 142 may be combined into fewer compute devices and/or distributed across more compute devices than those shown in FIG. 1.

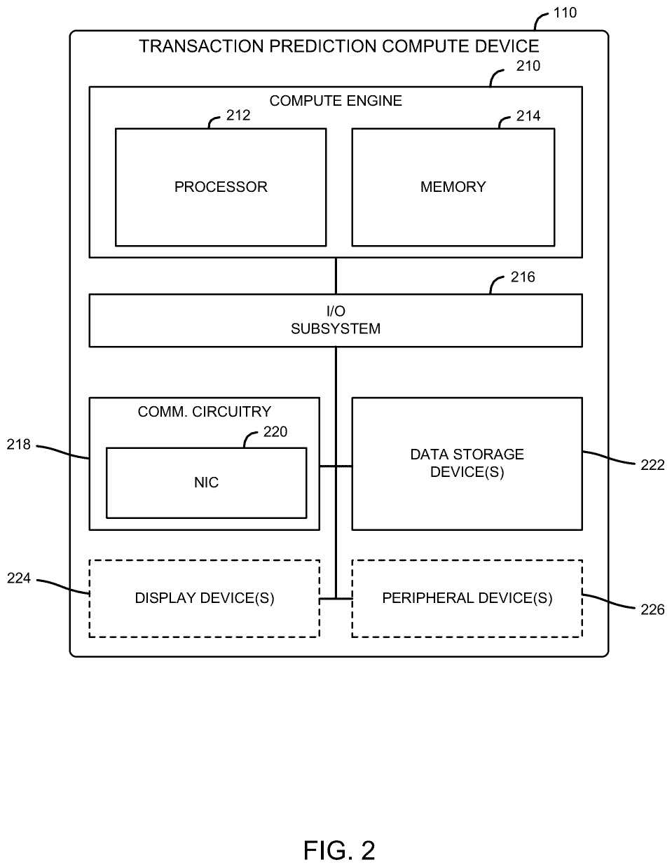

Referring now to FIG. 2, the illustrative transaction prediction compute device 110 includes a compute engine 210, an input/output (I/O) subsystem 216, communication circuitry 218, and one or more data storage devices 222. In some embodiments, the transaction prediction compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the transaction prediction compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as database records, applications, libraries, and drivers.

The compute engine 210 is communicatively coupled to other components of the transaction prediction compute device 110 via the I/O subsystem 216, which may be embodied as circuitry and/or components to facilitate input/output operations with the compute engine 210 (e.g., with the processor 212 and the main memory 214) and other components of the transaction prediction compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the transaction prediction compute device 110, into the compute engine 210.

The communication circuitry 218 may be embodied as any communication circuit, device, or collection thereof, capable of enabling communications over a network between the transaction prediction compute device 110 and another device (e.g., a compute device 112, 114, 130, 132, 140, 142, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the transaction prediction compute device 110 to connect with another compute device (e.g., a compute device 112, 114, 130, 132, 140, 142, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the transaction prediction compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the transaction prediction compute device 110 are housed in a single unit. However, in other embodiments, the components may be in separate housings, in separate racks of a data center, and/or spread across multiple data centers or other facilities. The compute devices 112, 114, 130, 132, 140, 142 may have components similar to those described in FIG. 2 with reference to the transaction prediction compute device 110. The description of those components of the transaction prediction compute device 110 is equally applicable to the description of components of the compute devices 112, 114, 130, 132, 140, 142. Further, it should be appreciated that any of the devices 112, 114, 130, 132, 140, 142 may include other components, sub-components, and devices commonly found in a computing device, which are not discussed above in reference to the transaction prediction compute device 110 and not discussed herein for clarity of the description.

In the illustrative embodiment, the compute devices 110, 112, 114, 130, 132, 140, 142, are in communication via a network 150, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

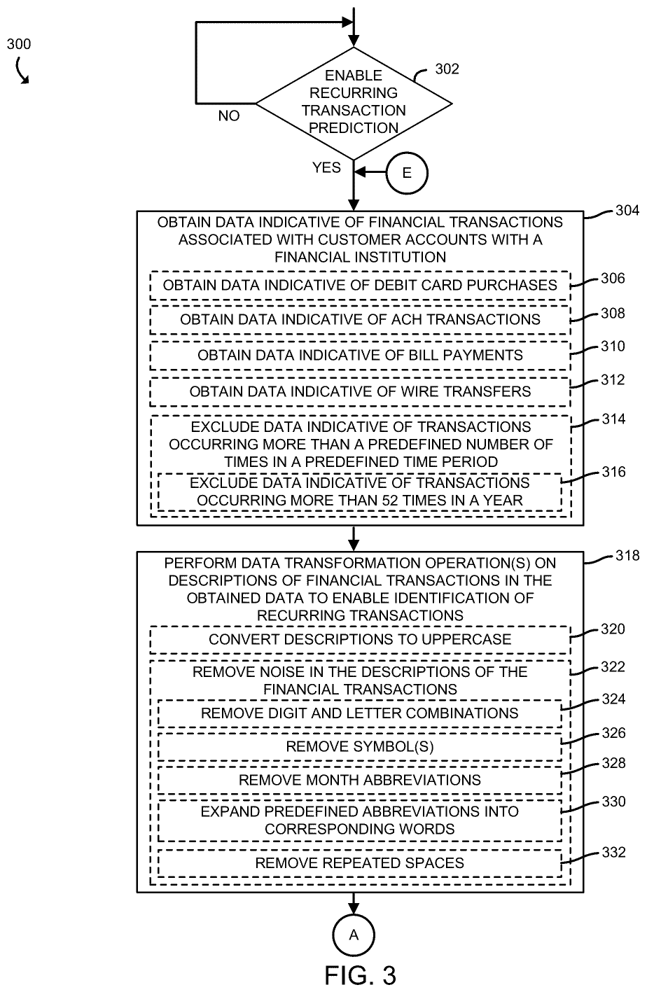

Referring now to FIG. 3, the system 100, and more specifically, the transaction prediction compute device 110, in the illustrative embodiment, may perform a method 300 for predicting recurring transactions. The method 300 begins with block 302 in which the transaction prediction compute device 110 determines whether to enable recurring transaction prediction. In doing so, the transaction prediction compute device 110 may determine to enable recurring transaction prediction in response to a determination that a configuration setting (e.g., in memory 214 or in storage 222) indicates to enable recurring transaction prediction, in response to receiving a request from another compute device to do so, and/or based on other factors. Regardless, in response to a determination to enable recurring transaction prediction, the method 300 advances to block 304 in which the transaction prediction compute device 110 obtains data indicative of financial transactions associated with customer accounts (e.g., checking accounts) with a financial institution (e.g., the financial institution 120).

As indicated in block 306, in obtaining data indicative of financial transactions, the transaction prediction compute device 110 may obtain data indicative of debit card purchases. The transaction prediction compute device 110 may additionally or alternatively obtain data indicative of automated clearing house (ACH) transactions, as indicated in block 308, bill payments, as indicated in block 310, and/or wire transfers, as indicated in block 312. In obtaining data indicative of financial transactions, the transaction prediction compute device 110, in the illustrative embodiment, excludes data indicative of transactions occurring more than a predefined number of times in a predefined time period, as indicated in block 314. For example, and as indicated in block 316, in some embodiments, the shortest recurrence interval for a recurring transaction may be defined as one week. In such embodiments, given that there are 52 weeks in a year, the transaction prediction compute device 110 may exclude data indicative of transactions occurring more than 52 times in a year.

Still referring to FIG. 3, the method 300 illustratively continues to block 318 in which the transaction prediction compute device 110 performs one or more data transformation operations on descriptions of the financial transactions in the obtained data to enable identification of recurring transactions (e.g., expenses, deposits, etc.). The data transformation operations, in some embodiments, utilize regular expression tokens to match text patterns and replace them. Table 1 below sets out regular expressions that may be used and their corresponding definitions.

TABLE 1

| Token | Definition |
|---|---|
| \w | Any word characters. Equivalent to |
| | [0-9A-Za-z] |
| \d | Any digit |
| a+ | One or more of a |
| a{3} | Exactly 3 of a |
| \b | A word boundary |
| [a-z] | A character in the range: a-z |
| (?<!...) | Negative lookbehind. Ensures that the given |
| | pattern would not match and end at the current |
| | position in the expression. The pattern must |
| | have fixed width. Does not consume |
| | characters. |
| (?:...) | Match everything enclosed. A non-capturing |
| | group allows quantifiers to be applied to part |
| | of the regular expression but does not |
| | capture/assign an ID. |

In performing data transformation operations, and as indicated in block 320, the transaction prediction compute device 110 converts the descriptions to uppercase. As indicated in block 322, the transaction prediction compute device 110 may remove noise (e.g., extraneous or obfuscating characters, numbers, and/or symbols) in the descriptions of the financial transactions. In doing so, and as indicated in block 324, the transaction prediction compute device 110 may remove predefined digit and letter combinations. For example, transaction descriptions associated with a particular merchant may list the merchant name with a nine character string of random numbers and letters concatenated to the end of the merchant's name. As such, for transactions that include the name of that merchant, the transaction prediction compute device 110 may execute a rule to remove the string of letters and numbers following the merchant's name. In the following exemplary table of transactions, the transaction prediction compute device 110 may remove the aforementioned strings of letter-number combinations from the merchant's name.

TABLE 2

| Before Cleaning | After Cleaning |
|---|---|
| Amazon.com*M24VF46S0 | Amazon.com* VIS 1222 |
| VIS 1222 Amzn.com/bi WA | Amzn.com/bi WA |
| Amazon.com*MH0876AV0 | Amazon.com* VIS 0708 |
| VIS 0708 Amzn.com/bi WA | Amzn.com/bi WA |
| Amazon.com*A28QX9743 | Amazon.com* VIS 0925 |
| VIS 0925 Amzn.com/bi WA | Amzn.com/bi WA |

The transaction prediction compute device 110 may also remove digit-letter combinations located at the beginning of a description. Such digit-letter combinations may include a serial number and an added grouping of letters and/or numbers. A regular expression that may be utilized to identify the pattern is “(\hat{ }\w+\d+\w+)”, meaning a digit-letter combination has either all digits or both digits and letters. Any description beginning with a sequence of only letters will not be identified as a digit-letter combination. Below is a table of descriptions processed by the above-described operation.

TABLE 3

| Before Cleaning | After Cleaning |
|---|---|
| WQG000000015229 PAYROLL | PAYROLL EQT |
| EQT CORPORATION | CORPORATION |
| 6N0L8DJA2G1 STDNT | STDNT |
| LOANFEDLOANSERVICING | LOANFEDLOANSERVICING |

Given that the above text processing rule only applies to digit-letter combinations located at the beginning of a description, the digit-letter combinations present in the descriptions in the table below are not removed.

TABLE 4

| Before Cleaning | After Cleaning |
|---|---|
| PAYROLL WQG000000015229 | PAYROLL WQG000000015229 |
| EQT CORPORATION | EQT CORPORATION |
| STDNT | STDNT |
| LOANFEDLOANSERVICING | LOANFEDLOANSERVICING |
| 6N0L8DJA2G1 | 6N0L8DJA2G1 |

The reason only the digit-letter combination located at the beginning of a transaction description, as distinguished from elsewhere in the description, is removed is that a middle portion of a transaction description often contains a merchant name which may be a digit-letter combination (e.g., “7-Eleven”). Below is an example of how the process affects such a description.

TABLE 5

| Before Cleaning | After Cleaning |
|---|---|
| 123122 7-Eleven | 7-Eleven |

Further, in at least some embodiments, the transaction prediction compute device 110 may remove strings of digits (e.g., strings that do not also include letters) that appear after digit-letter combinations in a transaction description. For example, in the description “T1059309991 8885963157LENDING CLUB” the main entity is “LENDING CLUB”. Having digits “8885963157” in the description makes it less expressive, more unique, and therefore less likely to be grouped with other similar “LENDING CLUB” descriptions for the same customer account (e.g., checking account). The transaction prediction compute device 110 removes numbers after removing the digit-letter combinations so that the random letters mixed in with the numbers are also removed. For example, in step 1, the transaction prediction compute device 110 may remove the digit-letter combination at the beginning of a description as follows:

TABLE 6

| Before Cleaning | After Cleaning |
|---|---|
| T1059309991 | 8885963157LENDING CLUB |
| 8885963157LENDING CLUB | |

In a subsequent step, the transaction prediction compute device 110 removes any digits in the description, as follows:

TABLE 7

| Before Cleaning | After Cleaning |
|---|---|
| 8885963157LENDING CLUB | LENDING CLUB |

In addition, in the illustrative embodiment, the transaction prediction compute device 110 removes any single characters in the description. Single characters, including letters and digits, in a description such as “P” in “P INSUR PREMERIE LIFE” are removed by the transaction prediction compute device 110.

The transaction prediction compute device 110 may additionally remove one or more predefined symbols, as indicated in block 326. In the illustrative embodiment, the transaction prediction compute device 110 may remove any symbol in the set of [“!”, “@”, “#”, “$”, “%”, “\hat{ }”, “&”, “*”, “(”, “)”, “′”, “−”, “.”, “+”, “˜”, “/”, “,” “<”, “>”, “?”, “\”, “_” ]. Further, the transaction prediction compute device 110 may remove month abbreviations from the descriptions, as indicated in block 328. That is, in the illustrative embodiment, the transaction prediction compute device 110 removes, from the descriptions, any instances of: “JAN”, “FEB”, “MAR”, “APR”, “MAY”, JUN”, “JUL”, “AUG”, “SEP”, “OCT”, “NOV”, “DEC”. In order to be removed, the month abbreviations must appear as standalone words (e.g., separated from other text by spaces). In the following table, the month abbreviations are removed to clarify that the transactions are in fact the same type of transaction. If month abbreviations are not removed, these month transactions are less likely to be grouped together and therefore the recurring pattern is less likely to be identified.

TABLE 8

| Before Cleaning | After Cleaning |
|---|---|
| 000987682 JAN INS | 000987682 JAN INS |
| ECON800-832-6858 | ECON800-832-6858 |
| 000987682 FEB INS | 000987682 FEB INS |
| ECON800-832-6858 | ECON800-832-6858 |
| 000987682 MAR INS | 000987682 MAR INS |
| ECON800-832-6858 | ECON800-832-6858 |
| 000987682 APR INS | 000987682 APR INS |
| ECON800-832-6858 | ECON800-832-6858 |
| 000987682 MAY INS | 000987682 MAY INS |
| ECON800-832-6858 | ECON800-832-6858 |

The transaction prediction compute device 110 may also expand predefined abbreviations in corresponding words, as indicated in block 330. For example, the transaction prediction compute device 110, in the illustrative embodiment, is configured to replace the abbreviations shown in the first column of the following table with the corresponding word or words shown in the second column of the table. In some embodiments, certain words must appear as a single word (e.g., requiring a space before and after the abbreviation). Others are not required to be a single word in order to be replaced and they may appear as a substring of a larger string. The column “single word” in the following table indicated if the word needs to be a single word (requiring spaces) to be replaced by the illustrative embodiment of the transaction prediction compute device 110. Referring to the table, as an example, “VIS” would need to be a single word with empty space surrounding it in order to be replaced by “VISA”. Similarly, words such as “VISION” also contain “VIS”, which, without the single words requirement, would result in a replacement using the term “VISAION”.

TABLE 9

| Original | Replacement | Single Word |
|---|---|---|
| MKTP or MKTPLACE | MARKETPLACE | True |
| INSPYMT | INSURANCE PAYMENT | False |
| PYMT or PMTS | PAYMENT | False |
| INS | INSURANCE | True |
| VIS | VISA | True |

Additionally, the transaction prediction compute device 110 may remove repeated spaces (e.g., replace instances of multiple spaces with a single space), as indicated in block 332. The table below illustrates the effects of a set of transformation or cleaning operations for text that may appear in a transaction description, a regular expression that may be used in the implementation of each operation, and replacement text resulting from each operation. In the illustrative embodiment, the operations are performed in the order shown (e.g., from top to bottom).

TABLE 10

| Original | Replacement | Single Word |
|---|---|---|
| 2. Remove digit letter | r‘AMAZON.COM\*[\w]{9}\b’ | ‘AMAZON.COM’ |
| combo in Amazon | | |
| description | | |
| 3. Remove digit letter | r‘(\hat{ }\w+\d+\w+)’ | ‘’ |
| combination at the | | |
| beginning of a description | | |
| 4. Remove digits | r‘[0-9]+’ | ‘’ |
| 5. Remove single | r‘((?<![\w])(?:[a-zA-Z0-9](?: \|$)))’ | ‘’ |
| character | | |
| 6. Remove symbols | r‘([!@#$%\hat{ }&*( )\grave{ }\-\+~∨,.< >?\\_])’ | ‘’ |
| 7. Remove month | r‘\bJAN\b\|\bFEB\b\|\bMAR\b\|\bAPR\b\|\ | |
| abbreviations | bMAY\b\|\bJUN\b\|\bJUL\b\|\bAUG\b\|\b | |
| | SEP\b\|\bOCT\b\|\bNOV\b\|\bDEC\b’ | |
| 8. Handle abbreviations | r‘\bMKTP\b\|\bMKTPLACE\b’ | ‘MARKETPLACE’ |
| 8. Handle abbreviations | r‘INSPYMT’ | ‘INSURANCE |
| | | PAYMENT’ |
| 8. Handle abbreviations | r‘PYMT\|PMTS’ | ‘PAYMENT’ |
| 8. Handle abbreviations | r‘\bINS\b’ | ‘INSURANCE’ |
| 8. Handle abbreviations | r‘\bVIS\b’ | ‘VISA’ |

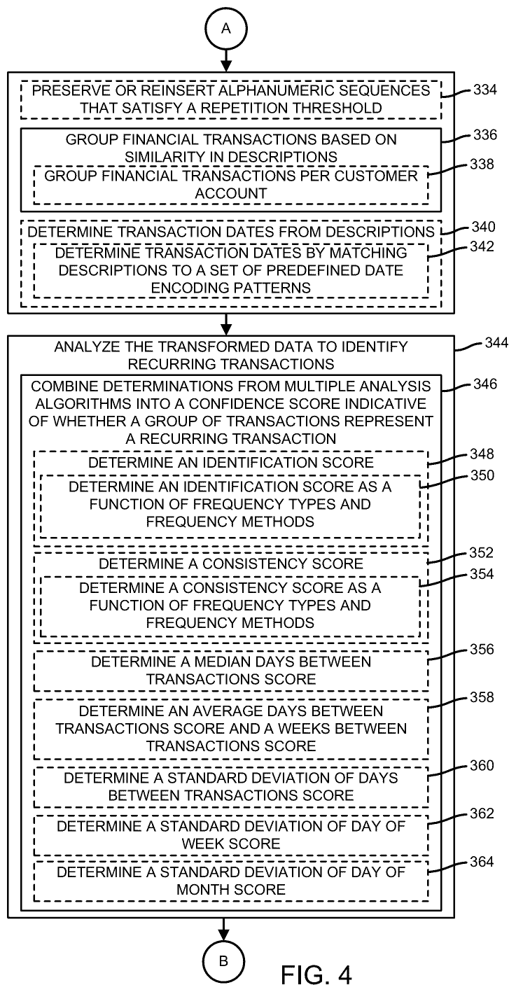

Referring now to FIG. 4, the transaction prediction compute device 110 may preserve or reinsert alphanumeric sequences that satisfy a repetition threshold, as indicated in block 334. That is, after the text-cleaning operations discussed above are performed, a subsequent step is the identification of any transactions that contain a repeating serial number at the beginning or end of their description. In the text cleaning step, the transaction prediction compute device 110 in the illustrative embodiment removes alpha-numeric sequences because they are often random and unique, thus reducing the likelihood that those transactions will be grouped together. In other cases, these alpha-numeric sequences serve as a unique identifier that distinguishes one transaction from another transaction. For example, the following descriptions each repeat several times:

TABLE 11

“31422 LEASECHG PNC EQUIPMENT FI”
“31422 LEASECHG PNC EQUIPMENT FI”
“31422 LEASECHG PNC EQUIPMENT FI”
“39019 LEASECHG PNC EQUIPMENT FI”
“39019 LEASECHG PNC EQUIPMENT FI”
“39019 LEASECHG PNC EQUIPMENT FI”

The five digits at the beginning are not random and serve to distinguish descriptions from each other. Since these digits are removed during the text cleaning process, all of these transactions would be incorrectly grouped together. As a result, if there are at least three identical transactions over a one year lookback with the same alpha-numeric sequence at the beginning or end of their descriptions, such as above, the transaction prediction compute device 110, in the illustrative embodiment, sets a repeating serial number indicator value of one (has_rep_ser=1) indicating that the description has a repeating serial number. After the sequence is removed in the text cleaning operations described above, the transaction prediction compute device 110 will concatenate the corresponding sequence back into the description of any transaction that has the repeating serial number indicator set to one. This allows alpha-numeric sequences to be preserved only in the descriptions where they serve as a unique identifier or serial number. In the illustrative embodiment, the transaction prediction compute device 110 also requires a numeric sequence to be at least five characters in length to be eligible as a repeating serial number. The transaction prediction compute device 110, in the illustrative embodiment, may subsequently group transaction descriptions at the account level.

The transaction prediction compute device 110, in the illustrative embodiment, groups financial transactions indicated in the obtained data based on similarity in their descriptions, as indicated in block 336. Further, in the illustrative embodiment, the transaction prediction compute device 110 groups the financial transactions by customer accounts, so that transactions associated with one customer's financial account are not grouped with transactions associated with another customer's financial account, as indicated in block 338. In block 340, the transaction prediction compute device 110 may determine transaction dates from the descriptions. In doing so, and as indicated in block 342, the transaction prediction compute device 110 determines the transaction dates by matching the descriptions to (e.g., comparing them to) a set of predefined date encoding patterns (e.g., to determine which encoding pattern is used and decode the date based on the matching pattern).

In some embodiments, the obtained data indicates the date that a transaction was posted to a database of financial transactions, but not the actual date of the transaction. The posting date may or may not be the same as the actual date that the underlying financial transaction occurred. However, the actual transaction date can be extracted from the description in many cases. For example, in the following example “APL* ITUNES.COM/BILL VIS 0810 866-7127753 CA”, the post date for the transaction is 2018-08-13 but “0810” in the description indicates the actual transaction date. Therefore “0810” is extracted from the description and concatenated with the year (e.g., the first four digits in the post date) to form an actual transaction date, “2018-08-10”. In the case when the actual transaction date is at year end and the year of posting_date is in the new year, (new_year−1), the year is concatenated to the month and day because concatenating the new year to the month and day of the previous year will give an incorrect future date. For example, a description may have “VIS 1228” and the posting_date is “2019-0101”. Concatenating “2019” to “1228” will give “2019-12-28” which is greater than the true posting_date. Instead, “2018” is concatenated to “1228” thereby giving the correct value of “2018-12-28”. There are mainly three types of patterns for actual transaction dates in a description as shown in the following table.

TABLE 12

| | |
|---|---|
| Type 1 | VIS MMdd - e.g. “VIS 0101” |
| Type 2 | NMMdd - e.g. “N0101” |
| Type 3 | (PE\|PY)MM/dd - e.g. “12/01” or “3/01” or |
| | “PE12/01” or “1/20/20” |

The following regular expressions may be used to extract actual transaction dates from transaction descriptions.

TABLE 13

| | | | | | Actual |
|---|---|---|---|---|---|
| Type | Regex | Explanation | Sample | Post Date | Date |
| 1 | r ‘( VIS \d{4} )’ | “VIS” followed | INTUIT | 2018 Dec. 26 | 2018 Dec. 24 |
| | | by a space and 4 | *PAYROLL VIS | | |
| | | digits and this | 1224 888- | | |
| | | letter-digit combo | 5377794 CA | | |
| | | needs to have a | | | |
| | | leading and trailing | | | |
| | | space which means | | | |
| | | it's single. | | | |
| 2 | r ‘( N\d{4} )’ | “N” followed by | NWB N0719 | 2019 Jul. 22 | 2019 Jul. 19 |
| | | 4 digits and this | 4953WAREN PA | | |
| | | letter-digit combo | | | |
| | | needs to have and | | | |
| | | leading a trailing | | | |
| | | space which means | | | |
| | | it's single. | | | |
| 3 | r‘(( +\| PE\| | The pattern starts | 00LEVINE | 2018 Mar. 2 | 2018 Mar. 2 |
| | PY)([0]{1}[1- | with a space or | PY03/02/18FLORIDA | | |
| | 9]{1}[1]{1}[0- | “PE” or “PY” | SUCCESS | | |
| | 2]{1}\|[1- | and then followed | | | |
| | 9]{1})∨([0]{1}[1- | by a valid 2-digit | | | |
| | 9]{1}\|[12]{1}[0- | month value eg. 02 | | | |
| | 9]\|[3]{1}[01]{1}))’ | or a 1-digit month | | | |
| | | value eg. 2, a “/” | | | |
| | | and a valid 2-digit | | | |
| | | day value. | | | |

In some embodiments, the transaction prediction compute device 110 may perform exception handling. That is, the actual transaction date extracted from the description may not always be a legitimate date. For example, if the transaction prediction compute device 110 finds “N2059” in the description, the transaction prediction compute device 110 may extract “2059” despite the number not representing a valid month-day combination. Therefore, in some embodiments, the transaction prediction compute device 110 may perform one or more failsafe processes to check for invalid extracted dates. In failsafe process 1, the transaction prediction compute device 110 checks if the actual transaction date is a legitimate date using the dayofweek( ) function in PySpark (a Python interface to Apache Spark, which is an analytics engine for large-scale data processing). The function will return null if the input date is invalid. In failsafe process 2, the transaction prediction compute device 110 checks if the actual transaction date is within a reasonable range around the post date. If the days difference between the actual transaction date and the post date is more than 7 days, the transaction prediction compute device 110 will determine that the extracted date is invalid. If an extracted transaction date is defined as invalid by either failsafe process, the transaction prediction compute device 110 replaces the extracted transaction date with the posting date.

The transaction prediction compute device 110 may execute further data cleaning or transformation operations as follows. In the illustrative embodiment, the transaction prediction compute device 110 operates on the assumption that for a given account and description group, there is only one occurrence of a transaction in a single day. Days between transactions and standard deviations can be distorted if the same type of transaction or purchase occurs multiple times in a single day for a given customer account. Each row of a final data set of transactions should be unique at an account number, description group (description after cleaning), and date level. When more than one transaction of the same description is present for a single day, the transaction prediction compute device 110 aggregates the transaction amounts together to provide a total for that day. Depending on the data on a daily level, three outcomes are possible. One outcome is only one entry. In that outcome, no aggregation is needed and the transaction prediction compute device 110 keeps the entry for that day. In another outcome, more than one entry with the same raw description (description before text cleaning) and transaction code is present. The transaction prediction compute device 110 illustratively aggregates these transactions together and sums the transaction amounts. In another outcome, more than one entry with the same cleaned description but with a different raw description (description before text cleaning) or transaction code is present. In such cases, the transaction prediction compute device 110 retains only one row (e.g., transaction record) and drops (e.g., deletes) the others. In such cases, the transaction prediction compute device 110 does not aggregate the transaction amounts.

Since different transactions under the same description group can have different full descriptions (used for extracting certain key words) or different transaction codes (used for determining if a transaction is recurring or not), the transaction prediction compute device 110 preserves the highest priority row. The transaction prediction compute device 110 assigns higher priority to recurring transaction codes and payroll transaction codes over other types. Examples of transaction data aggregation are provided below (description group is represented by the description label column). The following table includes initial records prior to data aggregation.

TABLE 14

| Description | Actual Trans | | | Tran | Trans |
|---|---|---|---|---|---|
| Label | Date | Description | Desc1 | Code | Amt |
| 000415 | Dec. 21, 2018 | 000415 | ACH | 1007 | 656.51 |
| PAYROLL | | PAYROLL | CREDIT | | |
| PURCHASE | | PURCHASE | 000415 | | |
| LINE | | LINE | | | |
| 000415 | Dec. 21, 2018 | 000415 | ACH | 1007 | 104.92 |
| PAYROLL | | PAYROLL | CREDIT | | |
| PURCHASE | | PURCHASE | 000415 | | |
| LINE | | LINE | | | |

For the transactions represented in the above table, the transaction prediction compute device 110 may aggregate the data (e.g., by “account_no”, “description_label”, “actual_trans_date”, “description”, “trans_code”) and sum up the transaction amounts (e.g., “trans_amt”). The resultant data is shown below.

TABLE 15

| Description | Actual Trans | | | Tran | Trans |
|---|---|---|---|---|---|
| Label | Date | Description | Desc1 | Code | Amt |
| 000415 | Dec. 21, 2018 | 000415 | ACH | 1007 | 761.43 |
| PAYROLL | | PAYROLL | CREDIT | | |
| PURCHASE | | PURCHASE | 000415 | | |
| LINE | | LINE | | | |

In the following example of dropping (e.g., deleting) duplicates, there are two records for the same description_label, same description, and same account on the same day. However, the records have different values for the trans_amt and desc1 fields. The initial records are shown below.

TABLE 16

| | | | | | Tran | |
|---|---|---|---|---|---|---|
| Description | Actual | | | Tran | Code | Trans |
| Label | Trans Date | Description | Desc 1 | Code | Order | Amt |
| BOB'S | Nov. 16, 2019 | BOB'S | DEBIT CARD | 1071 | 3 | 16.22 |
| PIZZA | | PIZZA VIS | PURCHASE | | | |
| VISA | | 1116 | 02541600014440845321 | | | |
| INDIANA | | INDIANA | | | | |
| PA | | PA | | | | |
| BOB'S | Nov. 16, 2019 | BOB'S | DEBIT CARD | 1071 | 3 | 7.46 |
| PIZZA | | PIZZA VIS | PURCHASE | | | |
| VISA | | 1116 | 14213600087917646321 | | | |
| INDIANA | | INDIANA | | | | |
| PA | | PA | | | | |

The transaction prediction compute device 110 may sort the above two records in increasing order by transaction code order (e.g., “trans_code_order”), description, “desc1” and transaction code (“trans_code”) and retain the first row. The resulting data is shown below.

TABLE 17

| | | | | | Tran | |
|---|---|---|---|---|---|---|
| Description | Actual | | | Tran | Code | Trans |
| Label | Trans Date | Description | Desc 1 | Code | Order | Amt |
| BOB'S | Nov. 16, 2019 | BOB'S | DEBIT CARD | 1071 | 3 | 16.22 |
| PIZZA | | PIZZA VIS | PURCHASE | | | |
| VISA | | 1116 | 02541600014440845321 | | | |
| INDIANA | | INDIANA | | | | |
| PA | | PA | | | | |

In preparing the data for subsequent analysis, the transaction prediction compute device 110 operates on the following parameters. One is that there should be no more than one entry per day for each transaction. If multiple transactions occur, they are handled in the aggregation operations described above. Further, a recurring transaction should not have more than 52 occurrences in a year. Any unprocessed transaction description that occurs more than 52 times over the past year are labelled by the transaction prediction compute device 110 as non-recurring. This rule helps reduce the workload and operations that the transaction prediction compute device 110 will perform at runtime.

Continuing the method 300, the transaction prediction compute device 110 analyzes the transformed date (e.g., transformed in block 318) to identify recurring transactions, as indicated in block 344. In doing so, and as indicated in block 346, the transaction prediction compute device 110 combines determinations (e.g., scores) from multiple analysis algorithms into a confidence score indicative of whether a given group of transactions represent a recurring transaction. That is, in the illustrative embodiment, the transaction prediction compute device 110 performs the operations associated with block 346 for each group that was created in block 336. The first two algorithms of scoring methods described below are focused on determining the frequency (e.g., weekly, biweekly, monthly, bimonthly, or quarterly) of a recurring transaction and the remaining algorithms or methods contribute to the determination of whether the transaction is indeed recurring. As a general principle, more frequent transaction intervals tend to have stricter restrictions on standard deviation days between and median days between compared to less frequent transactions. For example, a bimonthly transaction might not be exactly 60 days apart from the previous occurrence of the transaction, but the expectation is that a weekly transaction will occur in a more precise interval. Therefore, the amount of flexibility afforded to a bimonthly transaction (e.g., in the scoring system) is not also given to a weekly transaction. Quarterly transactions tend to have fewer possible points compared to the other frequency types due to the low amount of transactions available to review. True quarterly transactions will have, at most, three to four transactions in their history within a one year lookback window. Using repetitions of transactions in the last three and six months would not work for quarterly transactions because of the small transaction pool.

As indicated in block 348, the transaction prediction compute device 110 determines an identification score. In doing so, the transaction prediction compute device 110 determines the identification score as a function of frequency types and frequency methods, as indicated in block 350. Additionally, in the illustrative embodiment, the transaction prediction compute device 110 determines a consistency score, as indicated in block 352. In doing so, the transaction prediction compute device 110 may determine the consistency score as a function of frequency types and frequency methods, as indicated in block 354.

As indicated above, both scoring method 1 (e.g., identification score) and scoring method 2 (e.g., consistency score) use frequency type (“fregtype” methods). These are rules that will classify a transaction as weekly, biweekly, monthly, bimonthly, or quarterly depending on if they meet certain criteria. The transaction prediction compute device 110 determines an ID score based on the raw number of freqtype methods that are flagged. The formula is:

$$ID Score = \# methods flagged * 10 \qquad ( Equation 1 )$$

In the illustrative embodiment, it does not matter which frequency type (weekly, biweekly, etc.) is flagged. As long as one of the criteria is reached for a method, the transaction prediction compute device 110 assigns ten points. This score can sum to a total of 70 points if all freqtype methods are flagged. The transaction prediction compute device 110 determines the consistency score based on how many freqtype methods are flagged with the same result and the highest number of freqtype methods that are flagged as the same frequency type. The formula for the consistency score is as follows:

Consistency Score=Max #methods flagged as the same frequency type*10 (Equation 2)

If at least one method is flagged, then the transaction prediction compute device 110 awards ten points under the consistency score. If three of them are weekly and two of them are biweekly, then the transaction prediction compute device 110 awards 30 points since the highest number of the same type was three (weekly). A total of 70 points can be awarded if all of the freqtype methods scored are flagged as the same frequency. For example, if a transaction was flagged as weekly for all seven freqtype methods then the transaction would receive 70 points from the consistency score. The results from this method may be used in forecasting to determine the next predicted transaction date. If a majority of the transactions are under one frequency type, then in certain cases, the transaction prediction compute device 110 may forecast the prediction based on that frequency type. Below is a table showing each of the seven frequency type methods and the criteria needed to meet each of them. Two example are also provided below to clarify how scoring methods 1 and 2 work.

In example 1, if a transaction was flagged as weekly by method 2 and weekly by method 3, the identification score would be 20 [2 methods flagged*10] and the consistency score would be 20 [2 methods the same*10].

In example 2, if a transaction was flagged as weekly by method 1 and monthly by method 2, the identification score would be 20 [2 methods flagged*10] and the consistency score would be 10 [1 method the same*10].

TABLE 18

| Method | Weekly | Biweekly | Monthly | Bimonthly | Quarterly |
|---|---|---|---|---|---|
| 1 | 5 <= Median | 12 <= Median | 27 <= Median | 58 <= Median | 88 <= Median |
| | days between | days between | days between | days between | days between |
| | transactions <= 9 | transactions <= 16 | transactions <= 33 | transactions <= 63 | transactions <= 94 |
| | Standard | Standard | Standard | Standard | Standard |
| | deviation | deviation | deviation | deviation | deviation |
| | days between | days between | days between | days between | days between |
| | transactions < 2 | transactions < 3 | transactions < 5 | transactions < 5 | transactions < 5 |
| 2 | Average # of | Average # of | Average # of | Average # of | Average # of |
| | weeks between | weeks between | weeks between | weeks between | weeks between |
| | transactions = | transactions = | transactions = | transactions = | transactions = |
| | 1 (rounded to | 2 (rounded to | 4 or 5 | 8 or 9 | 12 or 13 |
| | nearest | nearest | (rounded to | (rounded to | (rounded to |
| | integer) | integer) | nearest | nearest | nearest |
| | | | integer) | | integer) |
| 3 | # repetitions | # repetitions | # repetitions | # repetitions | N/A |
| | in 6 months | in 6 months | in 6 months | in 6 months | |
| | between 23 | between 12 | between 5 | between 2 | |
| | and 29 AND | and 14 AND | and 7 AND | and 4 AND | |
| | Standard | Standard | Standard | Standard | |
| | deviation | deviation | deviation | deviation | |
| | days between | days between | days between | days between | |
| | transactions < 1 | transactions < 2 | transactions < 3 | transactions < 4 | |
| 4 | (Standard | (Standard | 27 <= | 57 <= | 88 <= |
| | deviation of | deviation of | Median days | Median days | Median days |
| | weekday of | weekday of | between | between | between |
| | transaction = | transaction = | transactions <= | transactions <= | transactions <= |
| | 0 AND | 0 AND | 33 AND | 64 AND | 94 AND |
| | Median days | Median days | Standard | Standard | Standard |
| | between | between | deviation | deviation | deviation |
| | transactions = 7) | transactions = 14) | days between | days between | days between |
| | OR: | OR: | transactions < | transactions < | transactions < |
| | (5 <= Median | (12 <= Median | 4 AND | 4 AND | 5 AND |
| | days between | days between | (Description | Description | Description |
| | transactions <= | transactions <= | has “ACH” | has “ACH” | has “ACH” |
| | 9 AND | 16 AND | OR | or “Payroll” | or “Payroll” |
| | Standard | Standard | “Payroll”) | | |
| | deviation | deviation | | | |
| | days between | days between | | | |
| | transactions < | transactions < | | | |
| | 2 AND | 3 AND | | | |
| | (Description | (Description | | | |
| | has “ACH” | has “ACH” | | | |
| | OR | OR | | | |
| | “Payroll”)) | “Payroll”)) | | | |
| 5 | Median days | Median days | Median days | Median days | Median days |
| | between | between | between | between | between |
| | transactions | transactions | transactions | transactions | transactions |
| | between 5 | between 11 | between 27 | between 57 | between 87 |
| | and 9 | and 17 | and 35 | and 67 | and 99 |
| 6 | # repetitions | # repetitions | # repetitions | N/A | N/A |
| | in 3 months | in 3 months | in 3 months | | |
| | between 10 | between 5 | between 2 | | |
| | and 16 | and 9 | and 4 | | |
| 7 | # repetitions | # repetitions | # repetitions | # repetitions | N/A |
| | in 6 months | in 6 months | in 6 months | in 6 months | |
| | between 22 | between 10 | between 5 | between 2 | |
| | and 30 | and 16 | and 7 | and 4 | |

The transaction prediction compute device 110 also determines a median days between transactions score, as indicated in block 356. The median days between transactions scoring method (method 3) uses the median days between transaction score to award points to transactions. Unlike methods 1 and 2, method 3 can give partial points if the transaction meets a less strict version of the rules. As before, there is a version for each frequency type (weekly, biweekly, etc.). These rules are less restrictive than the ones in methods 1 and 2 (identification score and consistency score) and will not have an impact on the forecasted date of the next transaction. If no set of criteria is met, then the transaction prediction compute device 110 awards zero points for the median days between transaction score. The table below gives the breakdown of this point distribution.

TABLE 19

| Points | | | | | |
|---|---|---|---|---|---|
| Awarded | Weekly | Biweekly | Monthly | Bimonthly | Quarterly |
| 10 | Median days | Median days | 30 <= Median | 60 <= Median | 90 <= Median |
| | between | between | days between | days between | days between |
| | transaction = 7 | transaction = 14 | transaction <= 32 | transaction <= 64 | transaction <= 96 |
| 8 | 6 <= Median | 13 <= Median | 29 <= Median | 59 <= Median | 89 <= Median |
| | days between | days between | days between | days between | days between |
| | transaction <= 8 | transaction <= 15 | transaction <= 33 | transaction <= 65 | transaction <= 97 |
| 6 | 5 <= Median | 12 <= Median | 28 <= Median | 58 <= Median | 88 <= Median |
| | days between | days between | days between | days between | days between |
| | transaction <= 9 | transaction <= 16 | transaction <= 34 | transaction <= 66 | transaction <= 98 |
| 4 | N/A | 11 <= Median | 27 <= Median | 57 <= Median | 87 <= Median |
| | | days between | days between | days between | days between |
| | | transaction <= 17 | transaction <= 35 | transaction <= 67 | transaction <= 99 |

Further, the transaction prediction compute device 110 determines an average days between transactions score, as indicated in block 358. The average days between transaction score (method 4) functions similarly to method 3, but instead is focused on the average days between transactions. The table below provides a breakdown for the point distribution for this method.

TABLE 20

| Points | | | | | |
|---|---|---|---|---|---|
| Awarded | Weekly | Biweekly | Monthly | Bimonthly | Quarterly |
| 10 | Average days | Average days | 30 <= Average | 60 <= Average | 90 <= Average |
| | between | between | days between | days between | days between |
| | transaction = 7 | transaction = 14 | transaction <= 32 | transaction <= 64 | transaction <= 96 |
| 8 | 6 <= Average | 13 <= Average | 29 <= Average | 59 <= Average | 89 <= Average |
| | days between | days between | days between | days between | days between |
| | transaction <= 8 | transaction <= 15 | transaction <= 33 | transaction <= 65 | transaction <= 97 |
| 6 | 5 <= Average | 12 <= Average | 28 <= Average | 58 <= Average | 88 <= Average |
| | days between | days between | days between | days between | days between |
| | transaction <= 9 | transaction <= 16 | transaction <= 34 | transaction <= 66 | transaction <= 98 |
| 4 | N/A | 11 <= Average | 27 <= Average | 57 <= Average | 87 <= Average |
| | | days between | days between | days between | days between |
| | | transaction <= 17 | transaction <= 35 | transaction <= 67 | transaction <= 99 |

The transaction prediction compute device 110 additionally determines a weeks between transactions score, as indicated in block 358. The weeks between score (method 5) focuses on the average number of weeks that occur between transactions to assign points. For less frequent ranges, there is a second category with less restrictive parameters to meet. The breakdown for each type is provided in the table below.

TABLE 21

| Points | | | | | |
|---|---|---|---|---|---|
| Awarded | Weekly | Biweekly | Monthly | Bimonthly | Quarterly |
| 10 | Average # | Average # | Average # | Average # | Average # |
| | weeks | weeks | weeks | weeks | weeks |
| | between | between | between | between | between |
| | repetition = 1 | repetition = 2 | repetition = | repetition = | repetition = |
| | | | 4 or 5 | 8 or 9 | 12 or 13 |
| 5 | N/A | N/A | Average # | Average # | Average # |
| | | | weeks | weeks | weeks |
| | | | between | between | between |
| | | | repetition = 3 | repetition = 10 | repetition = 14 |

Further, the transaction prediction compute device 110 determines a standard deviation of days between transaction score (method 6), as indicated in block 360. Scoring method 6 is focused on whether all transactions happen the same number of days apart. For example, if every transaction occurs seven days apart, then the transaction prediction compute device 110 would award ten points to the transactions under method 6. The further spaced out each interval is, the fewer points the transaction prediction compute device 110 awards under method 6. The point breakdown is shown below.

TABLE 22

| Points Awarded | Criteria |
|---|---|
| 10 | standard deviation of days between = 0 |
| 8 | 0 <standard deviation of days between <= 1 |
| 6 | 1 <standard deviation of days between <= 2 |
| 4 | 2 <standard deviation of days between <= 3 |
| 2 | 3 <standard deviation of days between <= 4 |

Further, the transaction prediction compute device 110 determines a standard deviation of day of week score (method 7), as indicated in block 362. Five points can be awarded if every transaction in the label falls on the same day of the week. For example, if all three transactions in one description group were on a Monday, they would receive five points. The table below sets out the criteria for the assignment of points.

TABLE 23

| Points Awarded | Criteria |
|---|---|
| 5 | standard deviation of day of week = 0 |

In addition, the transaction prediction compute device 110 determines a standard deviation of day of month score (method 8), as indicated in block 364. Scoring method 8 is based on identifying when each transaction falls on the exact same day of the month. For example, if each transaction in a group fell on the second day of the month, then the transaction prediction compute device 110 would assign 10 points to the group of transactions. The transactions can still receive points if they are close to the same day as each other. The breakdown of points is set out below.

TABLE 24

| Points Awarded | Criteria |
|---|---|
| 10 | standard deviation of day of month = 0 |
| 8 | 0 <Standard deviation of day of month <= 1 |
| 6 | 1 <Standard deviation of day of month <= 2 |
| 4 | 2 <Standard deviation of day of month <= 3 |
| 2 | 3 <Standard deviation of day of month <= 4 |

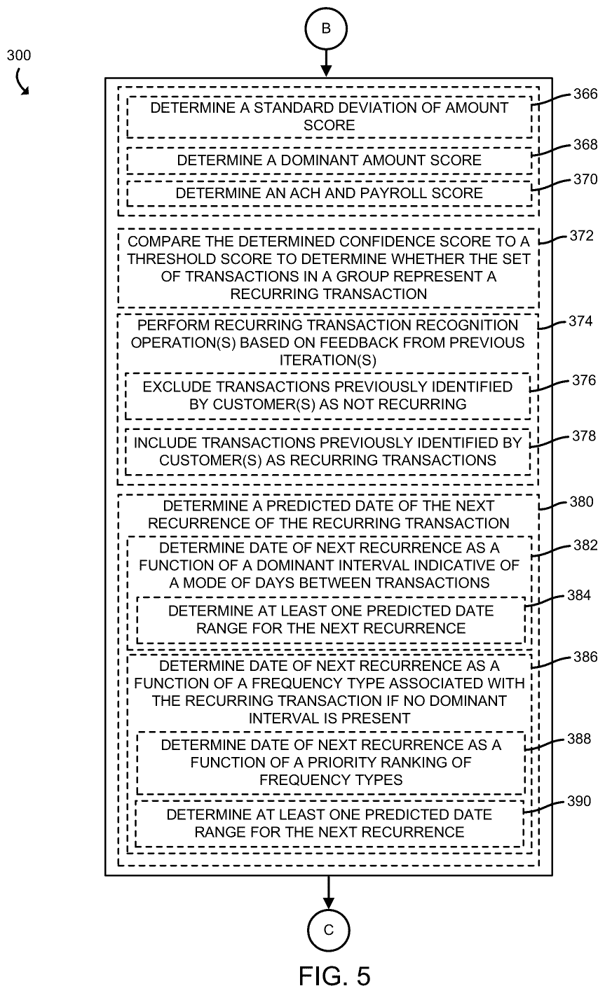

Referring now to FIG. 5, the transaction prediction compute device 110 determines a standard deviation of amount score (method 9), as indicated in block 366. Under scoring method 9, the transaction prediction compute device 110 assigns points depending on how similar the transaction amounts in a group are. If there is no difference between the amounts, the transaction prediction compute device 110 assigns ten points. Fewer points are awarded depending on how far from zero the standard deviation is. The breakdown of points is set forth in the table below.

TABLE 25

| Points Awarded | Criteria |
|---|---|
| 10 | standard deviation of amount = 0 |
| 8 | 0 <standard deviation of amount <= 2 |
| 6 | 2 <standard deviation of amount <= 5 |
| 4 | 5 <standard deviation of amount <= 10 |
| 2 | 10 <standard deviation of amount <= 20 |

Further the transaction prediction compute device 110 determines a dominant amount score (method 10), as indicated in block 368. The transaction prediction compute device 110 determines that a dominant amount is present when the same exact transaction amount appears three or more times in the obtained transaction data (e.g., over the course of a year) and appears more than any other transaction amount. If a dominant amount is present, the transaction prediction compute device 110 awards ten points. Otherwise, the transaction prediction compute device 110 awards zero points. In addition, the transaction prediction compute device 110 determines an automated clearing house (ACH) and payroll score (method 11), as indicated in block 370. In this scoring method, if the description contains the words “ACH” or “payroll”, the transaction prediction compute device 110 will award five points. Otherwise, the transaction prediction compute device 110 awards no points.

The transaction prediction compute device 110 compares the determined confidence score (i.e., the sum of the scores from the above 11 scoring methods) to a threshold score to determine whether the set of transactions in a group represent a recurring transaction, as indicated in block 372. The maximum possible score based on the above scoring methods is 220. The score assigned is divided by 220 to give a score out of 100 that will be used as the final confidence score. Based on experimentation, a threshold score of 50 is ideal for providing high performance for recall, precision, and accuracy. In addition to the above scoring methods, in the illustrative embodiment, the transaction prediction compute device 110 may also apply the following rules to transactions. One is that transactions with less than three occurrences in the transaction data (e.g., past twelve months) are flagged as non-recurring. Second, transactions with recurring transaction codes 7071 (RECURRING DEBIT PURCHASE), 2612 (ACH WEB-RECUR), 2922 (ACH TEL-RECUR), and 2845 (ACH WEB PAYMENT-RECUR) are automatically flagged as recurring. Third, if the difference in days between a transaction's last post date and an account's last post date is greater than 3*periodicity, then the transaction prediction compute device 110 defines the transaction as non-recent and sets a corresponding recency flag (“recency flag”) to “F”. Periodicity is defined as: 1) Weekly—7 days; 2) Biweekly—14 days; 3) Monthly—30 days; 4) Bimonthly—60 days; 5) Quarterly—90 days.

In block 374, the transaction prediction compute device 110 may perform one or more recurring transaction recognition operations based on feedback from previous iterations of the method 300. In doing so, the transaction prediction compute device 110 may exclude transactions that were previously identified by one or more customers as not recurring transactions (e.g., one or more customers flagged a detected transaction as not a recurring transaction), as indicated in block 376. Additionally or alternatively, the transaction prediction compute device 110 may include one or more transactions that were previously identified by one or more customers as recurring transactions, as indicated in block 378.

In block 380, the transaction prediction compute device 110 may determine a predicted date of the next recurrence of a recurring transaction (e.g., if the set of transactions have been determined to indeed be a recurring transaction). In doing so, and as indicated in block 382, the transaction prediction compute device 110 illustratively determines the date of the next recurrence of the expanse as a function of a dominant interval indicative of a mode of days between the transactions associated with the recurring transaction. The transaction prediction compute device 110 may determine at least one predicted date range for the next recurrence, as indicated in block 384.

A dominant interval is defined as the mode of days between transactions or the most frequently appearing number of days between transactions. If a dominant interval exists between transaction dates, then the transaction prediction compute device 110 uses that dominant interval to forecast an exact date and a date range for the next transaction. For example, if the dominant interval of transactions is 28 days, then the transaction prediction compute device 110 determines that the forecast for the next transaction is 28 days later. Below is a set of exemplary logic for the exact forecast date, date range 1, and date range 2 if there is a dominant interval.

TABLE 26

| | Last transaction date + |
|---|---|
| Exact Forecast Date | dominant interval |
| Forecast Date Range 1 | 4 day time window: dominant |
| | interval ± 2 days |
| Forecast Date Range 2 | 10 day time window: dominant |
| | interval ± 5 days |

If no dominant interval is present, the transaction prediction compute device 110 may determine the date of the next recurrence of the transaction as a function of a frequency type (e.g., weekly, biweekly, monthly, bimonthly, or quarterly) associated with the recurring transaction, as indicated in block 386. In doing so, and as indicated in block 388, the transaction prediction compute device 110 may determine the date of the next recurrence as a function of a priority ranking of frequency types. As indicated in block 390, the transaction prediction compute device 110 may determine at least one predicted date range, based on the frequency types, for the next recurrence.

If a transaction is only flagged as one frequency type from the methods in the freqtype methods table above (Table 18), then the transaction prediction compute device 110 may use that frequency type for the forecast date. For example, if a transaction is only flagged as weekly when scored by methods 1 through 7 above, then the transaction prediction compute device 110 determines that the frequency type is weekly. In addition, if it is flagged as weekly under frequency type methods 1 through 4 and is not flagged as any of the five frequency types under frequency type methods 5 through 7, then it is still considered a weekly transaction by the transaction prediction compute device 110. If a transaction is flagged as multiple frequency types from the frequency type methods in Table 18 above, but one frequency type is flagged the most, then the transaction prediction compute device 110 uses that frequency for the forecast date. For example, if a transaction is flagged as weekly twice, biweekly three times, and monthly twice, then the transaction prediction compute device 110, in the illustrative embodiment, determines that the transaction is biweekly. If a transaction is flagged as multiple frequency types from the frequency type methods set out in Table 18 and more than one type appears the most, then the transaction prediction compute device 110 determines the frequency type based on a priority ranking where the seven methods are ranked in order of importance. The priority ranking is set forth below.

TABLE 27

| Rank | Frequency Type Method |
|---|---|
| 1 | Method 2 |
| 2 | Method 1 |
| 3 | Method 5 |
| 4 | Method 4 |
| 5 | Method 3 |
| 6 | Method 7 |
| 7 | Method 6 |

If either of the two most-often flagged frequency types are flagged in method 2, then the transaction prediction compute device 110 uses that frequency type for the forecast date. If not, then the transaction prediction compute device 110 uses the next method in priority ranking, and so on. For example if a transaction is flagged as weekly twice, biweekly twice, and monthly once, then the transaction prediction compute device 110 uses the priority ranking. If method 2 flags the transaction as weekly, then the transaction prediction compute device 110 determines that the transaction is weekly. If the transaction prediction compute device 110 executing method 2 flags the transaction as biweekly, then the transaction prediction compute device 110 determines that the transaction is biweekly. If the transaction prediction compute device 110, executing method 2, does not flag the transaction as either weekly or biweekly, then it checks method 1, and so on.

Below is a table of logic that may be used for the exact forecast date, forecast date range 1, and forecast date range 2 if there is not a dominant interval.

TABLE 28

| Frequency Type | Exact Forecast Date | Forecast Date Range 1 | Forecast Date Range 2 |
|---|---|---|---|
| Weekly (1) | Exactly 7 | 2 day time window: | 4 day time window: |
| | days from last | 6-8 days from last | 5-9 days from last |
| | transaction date | transaction date | transaction date |
| Biweekly (2) | Exactly 14 | 4 day time window: | 8 day time window: |
| | days from last | 12-16 days from last | 10-18 days from last |
| | transaction date | transaction date | transaction date |
| Monthly (3) | Exactly 30 | 6 day time window: | 12 day time window: |
| | days from last | 27-33 days from last | 24-36 days from last |
| | transaction date | transaction date | transaction date |
| Bimonthly (4) | Exactly 60 | 14 day time window: | 28 day time window: |
| | days from last | 53-67 days from last | 46-74 days from last |
| | transaction date | transaction date | transaction date |
| Quarterly (5) | Exactly 90 | 14 day time window: | 28 day time window: |
| | days from last | 83-97 days from last | 76-104 days from last |
| | transaction date | transaction date | transaction date |

If the recurring transaction has one or more of the following unique patterns, the transaction prediction compute device 110 may reassign the exact forecast date based on a different rule. While the recurring framework aims to classify predictions as weekly, biweekly, monthly, bimonthly, or quarterly, in some cases the transactions may fall into more specific patterns. A good example is rent. For many apartments, the rent is not due in 30 days but on the last business day of the month. Since different months have different amounts of days, a forecast 30 days does not give the most accurate predicted date possible.

Under a last business day of month rule, the transaction prediction compute device 110 captures cases where every transaction occurs on the last business day of the month. If the transaction meets the criteria, the transaction prediction compute device 110 overwrites the original forecasted date with the new one that matches this business day pattern. Under a same day of month rule, the transaction prediction compute device 110 captures cases in which every transaction occurs on the same day of the month. For example a monthly transaction may always occur on the 25^{th} day of every month. If the transaction meets this criteria, the transaction prediction compute device 110 overwrites the original forecasted date with a new one that matches this day of month pattern. Under a same weekday and week of month rule, the transaction prediction compute device 110 captures cases in which every transaction occurs on the same day of the week and the same week of the month. For example, a monthly transaction may always occur on the second Tuesday of every month. If the transaction meets this criteria, the transaction prediction compute device 110 overwrites the original forecasted date with a new one that matches this day of week and week of month pattern. In these cases, the transaction prediction compute device 110 narrows date range 1 and date range 2 (e.g., by 50%) because a more precise pattern has been found. Below is a table of the logic associated with the above rules.

TABLE 29

| | Monthly | Bimonthly | Quarterly |
|---|---|---|---|
| Transaction always | Forecast date = last | Forecast date = last | Forecast date = last |
| happens on the last | business day of | business day of | business day of |
| business day | (current | (current | (current |
| (same_last_busday = 1) | month + 1) | month + 2) | month + 3) |
| Transaction always | Forecast date = | Forecast date = | Forecast date = |
| happens on the same | month(actual | month(actual | month(actual |
| day of month | transaction | transaction | transaction |
| (std_monthday = 0) | date) + 1 | date) + 2 | date) + 3 |
| Transaction always | Forecast date = actual | N/A | N/A |
| happens on the same | transaction date + # | | |
| weekday and week of | of days until same | | |
| month (std_wkday = 0, | week of month and | | |
| std_weekofmonth = 0) | weekday for | | |
| | following month, | | |
| | either 28 or 35 days | | |

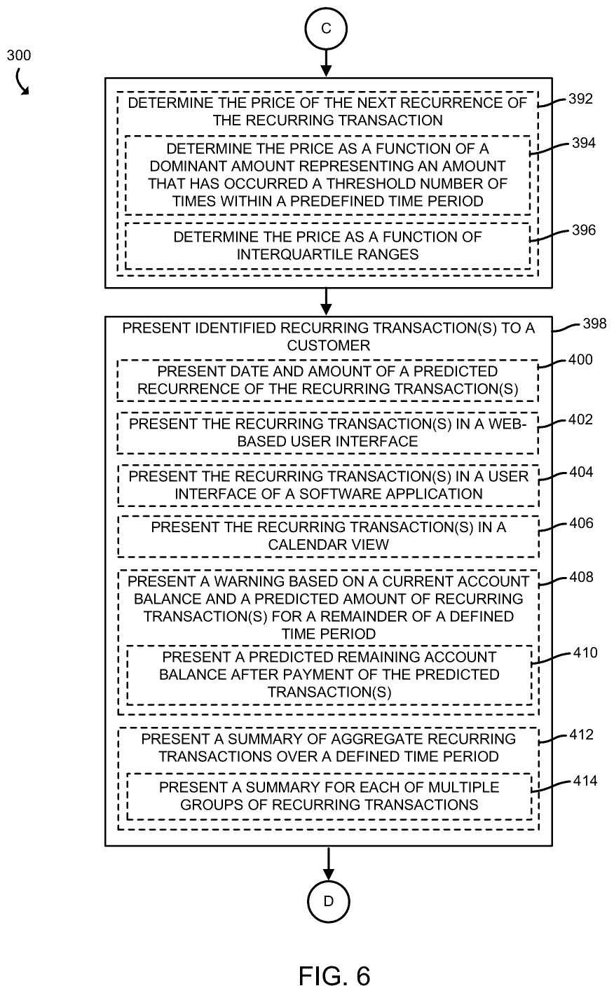

Referring now to FIG. 6, the transaction prediction compute device 110 may determine (e.g., predict) the price of the next recurrence of the recurring transaction, as indicated in block 392. In doing so, and as indicated in block 394, the transaction prediction compute device 110 may determine the price as a function of a dominant amount representing an amount that has occurred a threshold number of times within a predefined time period. In some embodiments, the transaction prediction compute device 110 determines the price as a function of interquartile ranges, as indicated in block 396. In order to predict transaction amounts, in the illustrative embodiment, the transaction prediction compute device 110 checks the description group to determine if it has a dominant amount. If it does, then the transaction prediction compute device 110 assigns the dominant amount as the predicted amount. If there is no dominant amount, the transaction prediction compute device 110 may use an interquartile range (IQR) as referenced above, to bucket the transaction amounts in the corresponding group into different segments. With the method described below, transaction amounts within the same segment will have less volatility (e.g., the amount of variance for each successive transaction<IQR) and therefore, similar magnitude. Instead of calculating the average amount over the entire transaction group, which is easily affected by outliers, the transaction prediction compute device 110 calculates the predicted amount by taking the average transaction amount over the segment with the highest number of transactions. The steps used by the transaction prediction compute device 110 in the illustrative embodiment are set out below.

TABLE 30

| | |
|---|---|
| 1 | Calculate the 25th percentile, median, and 75th percentile of the transaction amount for |
| | the given description group. |
| 2 | Calculate the first interquartile range (IQR1 = Median − 25th percentile) and the second |
| | interquartile range (IQR 2 = 75th percentile − Median). |
| 3 | Choose the smaller of the first or second interquartile range as the metric for |
| | segmentation. |
| 4 | Sort the transaction amount within a description group in ascending order. |
| 5 | For each transaction within the description group, calculate the amount difference |
| | between current transaction amount and previous transaction amount. |
| 6 | If amount difference is greater than the smaller interquartile range calculated in step 3, |
| | the transaction will be assigned to a new segment. |
| 7 | After segmenting transactions, take the segment with the highest number of transactions |
| | and calculate its average. The calculated average is the predicted amount. |

In the illustrative embodiment, the transaction prediction compute device 110 performs the above prediction operations (e.g., of date and monetary amount) for each recurring transaction that was detected. Continuing the method 300, the transaction prediction compute device 110 presents the identified recurring transaction(s) to a customer, as indicated in block 398. In doing so, and as indicated in block 400, the transaction prediction compute device 110 presents the date and amount (e.g., monetary amount) of a predicted recurrence of a recurring transaction(s). In some embodiments, the transaction prediction compute device 110 presents the recurring transaction(s) in a web-based user interface, as indicated in block 402. That is, the transaction prediction compute device 110 sends, to a corresponding compute device (e.g., customer compute device 130, 132) code (e.g., hyper-text markup language, JavaScript, etc.) and data (e.g., image data, text, etc.) in to be rendered into a user interface by a web browser executed by the receiving compute device (e.g., customer compute device 130, 132).

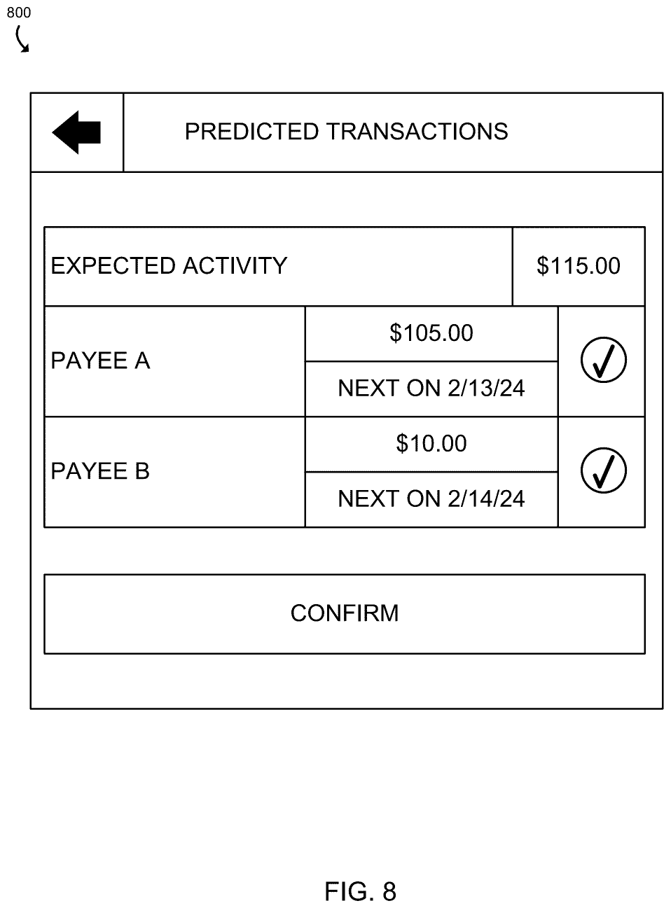

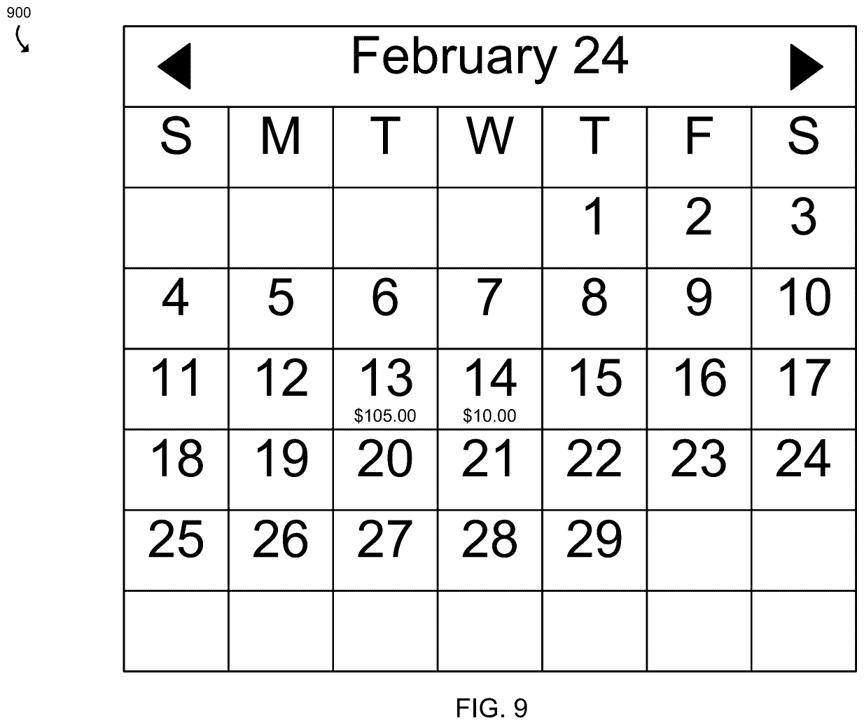

As indicated in block 404, the transaction prediction compute device 110 may present the recurring transaction(s) in a user interface of a software application (e.g., executed by a corresponding compute device, such as the customer compute device 130, 132). That is the transaction prediction compute device 110 may send data and/or code usable by the software application (e.g., a banking application associated with the financial institution 120) to display the recurring transaction(s). In some embodiments, the transaction prediction compute device 110 may present the recurring transaction(s) in a calendar view (e.g., a month view), indicating the date on which each transaction is predicted to occur, as indicated in block 406. The transaction prediction compute device 110 may present a warning based on a current account balance and a predicted amount of recurring transactions for a remainder of a defined time period, as indicated in block 408. In doing so, the transaction prediction compute device 110 may present a predicted remaining account balance after payment of the predicted transactions, as indicated in block 410. In some embodiments, the transaction prediction compute device 110 may present a summary of aggregate recurring transactions over a defined time period, as indicated in block 412. As indicated in block 414, the transaction prediction compute device 110 may present a summary for each of multiple groups of recurring transactions. That is, the transaction prediction compute device 110 may provide a spending analysis that indicates how much money a given customer spends per month (or other defined time period) on each of multiple categories (e.g., utilities, entertainment, etc.) or each of multiple payees (e.g., names of merchants). FIGS. 8 and 9 illustrate embodiments of user interfaces 800, 900 that may be produced by the transaction prediction compute device 110.

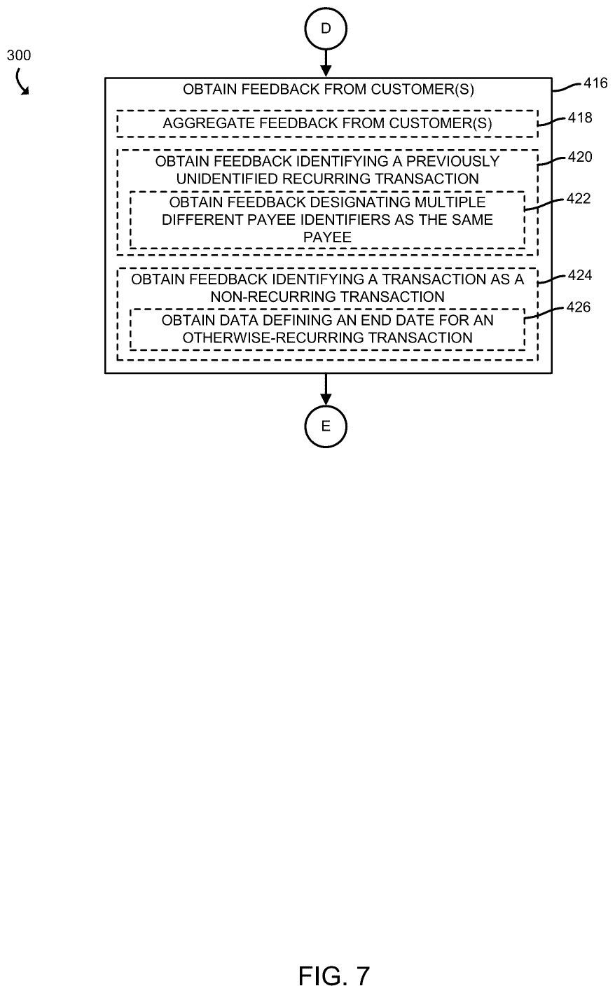

The method 300 continues to block 416 of FIG. 7, in which the transaction prediction compute device 110 may obtain feedback from the customer(s). In doing so, and as indicated in block 418, the transaction prediction compute device 110 may aggregate data from multiple customers (e.g., received from multiple customer compute devices 130, 132) to identify common feedback. The transaction prediction compute device 110 may obtain feedback identifying, as a recurring transaction, a previously unidentified recurring transaction, as indicated in block 420. For example, and as indicated in block 422, the transaction prediction compute device 110 may obtain feedback designating multiple different payee identifiers as the same payee. As indicated in block 424, the transaction prediction compute device 110 may obtain feedback identifying a transaction (e.g., a transaction that was determined by the transaction prediction compute device 110 to be a recurring transaction) as a non-recurring transaction. For example, the transaction may have been recurring but the customer knows that the recurring transactions will stop as of a defined date (e.g., based on a contract between the customer and the payee). Accordingly, and as indicated in block 426, the transaction prediction compute device 110 may obtain data defining an end date for an otherwise-recurring transaction. In the illustrative embodiment, having obtained customer feedback, the method 300 loops back to block 304, in which the transaction prediction compute device 110 obtains further financial transaction data for analysis.

The above-described model (e.g., the method 300) may be based on a static and fixed lookback window, rather than a rolling lookback window. In the illustrative embodiment, the transaction prediction compute device 110, utilizing the model, rewrites the history of the output variables (e.g., recurring flag, predicted amount, and forecast date) every time the scoring function is called (e.g., executed). For example, if it takes eight transactions to correctly label a heating payment as recurring, when the model updates on the 8^{th} time, the transaction prediction compute device 110 will label all eight transactions as recurring transactions and overwrite the past seven false labels as true. An alternative to overwriting the data history is to create a daily appending data archive table to store the original prediction information for each transaction (“original” meaning when the transaction first enters the table) where this information does not change from run to run (e.g., each execution of the method 300). Thus, the new entries from the scoring model are appended to the data archive table rather than overwriting the data history. As an example of this process, a sample data archive table is provided below. By definition, the first two records have recurring_flag as False because the model (e.g., the transaction prediction compute device 110 executing the method 300) flags transactions with fewer than three occurrences as not recurring by default. The next three transactions capture the recurring nature of the transaction. In the table set out below, every historical entry is retained.

TABLE 31

| Post_dte | Description | Trans_amt | Recurring_flag |
|---|---|---|---|
| Jul. 8, 2021 | Netflix | 10 | F |
| Aug. 8, 2021 | Netflix | 10 | F |
| Sep. 8, 2021 | Netflix | 10 | T |
| Oct. 8, 2021 | Netflix | 10 | T |
| Nov. 8, 2021 | Netflix | 10 | T |

However, in the model output table, the first two records will be rewritten by “T” because the model (e.g., the transaction prediction compute device 110) identifies the Netflix transaction as recurring since there are more than three occurrences in the transaction history. In this table, historical results are overwritten by the transaction prediction compute device 110.

TABLE 32

| Post_dte | Description | Trans_amt | Recurring_flag |
|---|---|---|---|
| Jul. 8, 2021 | Netflix | 10 | T |
| Aug. 8, 2021 | Netflix | 10 | T |
| Sep. 8, 2021 | Netflix | 10 | T |
| Oct. 8, 2021 | Netflix | 10 | T |
| Nov. 8, 2021 | Netflix | 10 | T |

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### Examples

Illustrative examples of the technologies disclosed herein are provided below. An embodiment of the technologies may include any one or more, and any combination of, the examples described below.

Example 1 includes a compute device comprising circuitry configured to obtain data indicative of financial transactions associated with one or more customer accounts with a financial institution; perform at least one data transformation operation on descriptions of the financial transactions in the obtained data to enable identification of recurring transactions, including grouping the financial transactions based on a similarity of the descriptions; combine determinations from multiple analysis algorithms executed on a group of the financial transactions to obtain a confidence score indicative of whether the group of transactions represents a recurring transaction; and present, in response to a determination that the confidence score indicates that the group of financial transactions represents a recurring transaction, a predicted amount and date for a recurrence of the recurring transaction.

Example 2 includes the subject matter of Example 1, and wherein to obtain data indicative of financial transactions comprises to obtain data indicative of debit card purchases.

Example 3 includes the subject matter of any of Examples 1 and 2, and wherein to obtain data indicative of financial transactions comprises to obtain data indicative of automated clearing house transactions.

Example 4 includes the subject matter of any of Examples 1-3, and wherein to obtain data indicative of financial transactions comprises to obtain data indicative of bill payments.

Example 5 includes the subject matter of any of Examples 1-4, and wherein to obtain data indicative of financial transactions comprises to obtain data indicative of wire transfers.

Example 6 includes the subject matter of any of Examples 1-5, and wherein to obtain data indicative of financial transactions comprises to exclude data indicative of transactions occurring more than a predefined number of times in a predefined time period.

Example 7 includes the subject matter of any of Examples 1-6, and wherein to exclude data indicative of transactions occurring more than a predefined number of times in a predefined time period comprises to exclude data indicative of transactions occurring more than 52 times in a year.

Example 8 includes the subject matter of any of Examples 1-7, and wherein to perform at least one data transformation operation comprises to convert the descriptions to uppercase.

Example 9 includes the subject matter of any of Examples 1-8, and wherein to perform at least one data transformation operation comprises to remove noise in the descriptions of the financial transactions.

Example 10 includes the subject matter of any of Examples 1-9, and wherein to remove noise comprises to remove digit and letter combinations.

Example 11 includes the subject matter of any of Examples 1-10, and wherein to remove noise comprises to remove one or more symbols.

Example 12 includes the subject matter of any of Examples 1-11, and wherein to remove noise comprises to remove month abbreviations.

Example 13 includes the subject matter of any of Examples 1-12, and wherein to remove noise comprises to expand predefined abbreviations into corresponding words.

Example 14 includes the subject matter of any of Examples 1-13, and wherein to remove noise comprises to remove repeated spaces.

Example 15 includes the subject matter of any of Examples 1-14, and wherein to perform at least one data transformation operation comprises to preserve or reinsert an alphanumeric sequence that satisfies a repetition threshold.

Example 16 includes the subject matter of any of Examples 1-15, and wherein the circuitry is configured to group financial transactions based additionally on a corresponding customer account associated with each financial transaction.

Example 17 includes the subject matter of any of Examples 1-16, and wherein to perform at least one data transformation operation comprises to determine transaction dates from the descriptions.

Example 18 includes the subject matter of any of Examples 1-17, and wherein to determine transaction dates from the descriptions comprises to determine transaction dates by matching the descriptions to a set of predefined date encoding patterns.

Example 19 includes the subject matter of any of Examples 1-18, and wherein to combine determinations from multiple analysis algorithms comprises determining an identification score.

Example 20 includes the subject matter of any of Examples 1-19, and wherein to determine an identification score comprises to determine the identification score as a function of frequency types and frequency methods.

Example 21 includes the subject matter of any of Examples 1-20, and wherein to combine determinations from multiple analysis algorithms comprises to determine a consistency score.

Example 22 includes the subject matter of any of Examples 1-21, and wherein to determine the consistency score comprises to determine the consistency score as a function of frequency types and frequency methods.

Example 23 includes the subject matter of any of Examples 1-22, and wherein to combine determinations from multiple analysis algorithms comprises to determine a median days between transactions score.

Example 24 includes the subject matter of any of Examples 1-23, and wherein to combine determinations from multiple analysis algorithms comprises to determine at least one of an average days between transactions score or a weeks between transactions score.

Example 25 includes the subject matter of any of Examples 1-24, and wherein to combine determinations from multiple analysis algorithms comprises to determine a standard deviation of days between transactions score.

Example 26 includes the subject matter of any of Examples 1-25, and wherein to combine determinations from multiple analysis algorithms comprises to determine a standard deviation of day of week score.

Example 27 includes the subject matter of any of Examples 1-26, and wherein to combine determinations from multiple analysis algorithms comprises to determine a standard deviation of day of month score.

Example 28 includes the subject matter of any of Examples 1-27, and wherein to combine determinations from multiple analysis algorithms comprises to determine a standard deviation of amount score.

Example 29 includes the subject matter of any of Examples 1-28, and wherein to combine determinations from multiple analysis algorithms comprises to determine a dominant amount score.

Example 30 includes the subject matter of any of Examples 1-29, and wherein to combine determinations from multiple analysis algorithms comprises to determine an automated clearing house and payroll score.

Example 31 includes the subject matter of any of Examples 1-30, and wherein the circuitry is further configured to compare the confidence score to a threshold score to determine whether the group of financial transactions represent a recurring transaction.

Example 32 includes the subject matter of any of Examples 1-31, and wherein the circuitry is further configured to perform a recurring transaction recognition operation based on feedback from a consumer indicating that transactions previously identified as recurring transactions are not recurring transactions or that transactions previously not identified as recurring transactions are recurring transactions.

Example 33 includes the subject matter of any of Examples 1-32, and wherein the circuitry is further configured to determine a predicted date for the recurrence of the recurring transaction as a function of a dominant interval indicative of a mode of days between financial transactions associated with the recurring transaction.

Example 34 includes the subject matter of any of Examples 1-33, and wherein the circuitry is further configured to determine a predicted date range for the recurrence of the recurring transaction.

Example 35 includes the subject matter of any of Examples 1-34, and wherein the circuitry is further configured to determine, in response to a determination that no dominant interval is present, a predicted date for the recurrence of the recurring transaction as a function of a frequency type associated with the recurring transaction.

Example 36 includes the subject matter of any of Examples 1-35, and wherein to determine the predicted date as a function of a frequency type comprises to determine the predicted date as a function of a priority ranking of the frequency types.

Example 37 includes the subject matter of any of Examples 1-36, and wherein to determine the predicted date as a function of the frequency type comprises to determine a predicted date range for the recurrence.

Example 38 includes the subject matter of any of Examples 1-37, and wherein the circuitry is further configured to determine the predicted price of the recurrence of the recurring transaction.

Example 39 includes the subject matter of any of Examples 1-38, and wherein to determine the predicted price comprises to determine the predicted price as a function of a dominant amount representing an amount that has occurred a threshold number of times within a predefined time period.

Example 40 includes the subject matter of any of Examples 1-39, and wherein to determine the predicted price comprises to determine the predicted price as a function of interquartile ranges.

Example 41 includes the subject matter of any of Examples 1-40, and wherein the circuitry is further configured to present the recurring transaction in a web-based user interface or a user interface of a software application.

Example 42 includes the subject matter of any of Examples 1-41, and wherein the circuitry is further configured to present the recurring transaction in a calendar view.

Example 43 includes the subject matter of any of Examples 1-42, and wherein the circuitry is further configured to present a warning based on a current account balance and a predicted amount of recurring transactions for a remainder of a defined time period.

Example 44 includes the subject matter of any of Examples 1-43, and wherein the circuitry is further configured to present a predicted remaining account balance after payment of the predicted amount.

Example 45 includes the subject matter of any of Examples 1-44, and wherein the circuitry is further configured to present a summary of aggregate recurring transactions over a defined time period.

Example 46 includes the subject matter of any of Examples 1-45, and wherein the circuitry is further configured to obtain feedback from one or more customers.

Example 47 includes the subject matter of any of Examples 1-46, and wherein the circuitry is further configured to aggregate feedback from multiple customers.

Example 48 includes the subject matter of any of Examples 1-47, and wherein the circuitry is further configured to obtain feedback identifying a previously unidentified recurring transaction or obtain feedback identifying a transaction as a non-recurring transaction.

Example 49 includes the subject matter of any of Examples 1-48, and wherein the circuitry is further configured to obtain feedback designating multiple different payee identifiers as the same payee.

Example 50 includes the subject matter of any of Examples 1-49, and wherein the circuitry is further configured to obtain data defining an end date for a recurring transaction.

Example 51 includes a method comprising obtaining, by a compute device, data indicative of financial transactions associated with one or more customer accounts with a financial institution; performing, by the compute device, at least one data transformation operation on descriptions of the financial transactions in the obtained data to enable identification of recurring transactions, including grouping the financial transactions based on a similarity of the descriptions; combining, by the compute device, determinations from multiple analysis algorithms executed on a group of the financial transactions to obtain a confidence score indicative of whether the group of transactions represents a recurring transaction; and presenting, by the compute device and in response to a determination that the confidence score indicates that the group of financial transactions represents a recurring transaction, a predicted amount and date for a recurrence of the recurring transaction.

Example 52 includes the subject matter of Example 51, and wherein obtaining data indicative of financial transactions comprises obtaining data indicative of debit card purchases.

Example 53 includes the subject matter of any of Examples 51 and 52, and wherein obtaining data indicative of financial transactions comprises obtaining data indicative of automated clearing house transactions.

Example 54 includes the subject matter of any of Examples 51-53, and wherein obtaining data indicative of financial transactions comprises obtaining data indicative of bill payments.

Example 55 includes the subject matter of any of Examples 51-54, and wherein obtaining data indicative of financial transactions comprises obtaining data indicative of wire transfers.

Example 56 includes the subject matter of any of Examples 51-55, and wherein obtaining data indicative of financial transactions comprises excluding data indicative of transactions occurring more than a predefined number of times in a predefined time period.

Example 57 includes the subject matter of any of Examples 51-56, and wherein excluding data indicative of transactions occurring more than a predefined number of times in a predefined time period comprises excluding data indicative of transactions occurring more than 52 times in a year.

Example 58 includes the subject matter of any of Examples 51-57, and wherein to performing at least one data transformation operation comprises converting the descriptions to uppercase.

Example 59 includes the subject matter of any of Examples 51-58, and wherein to performing at least one data transformation operation comprises removing noise in the descriptions of the financial transactions.

Example 60 includes the subject matter of any of Examples 51-59, and wherein removing noise comprises removing digit and letter combinations.

Example 61 includes the subject matter of any of Examples 51-60, and wherein removing noise comprises removing one or more symbols.

Example 62 includes the subject matter of any of Examples 51-61, and wherein removing noise comprises removing month abbreviations.

Example 63 includes the subject matter of any of Examples 51-62, and wherein removing noise comprises expanding predefined abbreviations into corresponding words.

Example 64 includes the subject matter of any of Examples 51-63, and wherein removing noise comprises removing repeated spaces.

Example 65 includes the subject matter of any of Examples 51-64, and wherein to performing at least one data transformation operation comprises preserving or reinserting an alphanumeric sequence that satisfies a repetition threshold.

Example 66 includes the subject matter of any of Examples 51-65, and further including grouping, by the compute device, financial transactions based additionally on a corresponding customer account associated with each financial transaction.

Example 67 includes the subject matter of any of Examples 51-66, and wherein to performing at least one data transformation operation comprises determining transaction dates from the descriptions.

Example 68 includes the subject matter of any of Examples 51-67, and wherein determining transaction dates from the descriptions comprises determining transaction dates by matching the descriptions to a set of predefined date encoding patterns.

Example 69 includes the subject matter of any of Examples 51-68, and wherein combining determinations from multiple analysis algorithms comprises determining an identification score.

Example 70 includes the subject matter of any of Examples 51-69, and wherein determining an identification score comprises determining the identification score as a function of frequency types and frequency methods.

Example 71 includes the subject matter of any of Examples 51-70, and wherein combining determinations from multiple analysis algorithms comprises determining a consistency score.

Example 72 includes the subject matter of any of Examples 51-71, and wherein determining the consistency score comprises determining the consistency score as a function of frequency types and frequency methods.

Example 73 includes the subject matter of any of Examples 51-72, and wherein combining determinations from multiple analysis algorithms comprises determining a median days between transactions score.

Example 74 includes the subject matter of any of Examples 51-73, and wherein combining determinations from multiple analysis algorithms comprises determining at least one of an average days between transactions score or a weeks between transactions score.

Example 75 includes the subject matter of any of Examples 51-74, and wherein combining determinations from multiple analysis algorithms comprises determining a standard deviation of days between transactions score.

Example 76 includes the subject matter of any of Examples 51-75, and wherein combining determinations from multiple analysis algorithms comprises determining a standard deviation of day of week score.

Example 77 includes the subject matter of any of Examples 51-76, and wherein combining determinations from multiple analysis algorithms comprises determining a standard deviation of day of month score.

Example 78 includes the subject matter of any of Examples 51-77, and wherein combining determinations from multiple analysis algorithms comprises determining a standard deviation of amount score.

Example 79 includes the subject matter of any of Examples 51-78, and wherein combining determinations from multiple analysis algorithms comprises determining a dominant amount score.

Example 80 includes the subject matter of any of Examples 51-79, and wherein combining determinations from multiple analysis algorithms comprises determining an automated clearing house and payroll score.

Example 81 includes the subject matter of any of Examples 51-80, and further including comparing, by the compute device, the confidence score to a threshold score to determine whether the group of financial transactions represent a recurring transaction.

Example 82 includes the subject matter of any of Examples 51-81, and further including performing, by the compute device, a recurring transaction recognition operation based on feedback from a consumer indicating that transactions previously identified as recurring transactions are not recurring transactions or that transactions previously not identified as recurring transactions are recurring transactions.

Example 83 includes the subject matter of any of Examples 51-82, and further including determining, by the compute device, a predicted date for the recurrence of the recurring transaction as a function of a dominant interval indicative of a mode of days between financial transactions associated with the recurring transaction.

Example 84 includes the subject matter of any of Examples 51-83, and further including determining, by the compute device, a predicted date range for the recurrence of the recurring transaction.

Example 85 includes the subject matter of any of Examples 51-84, and further including determining, by the compute device and in response to a determination that no dominant interval is present, a predicted date for the recurrence of the recurring transaction as a function of a frequency type associated with the recurring transaction.

Example 86 includes the subject matter of any of Examples 51-85, and wherein determining the predicted date as a function of a frequency type comprises determining the predicted date as a function of a priority ranking of the frequency types.

Example 87 includes the subject matter of any of Examples 51-86, and wherein determining the predicted date as a function of the frequency type comprises determining a predicted date range for the recurrence.

Example 88 includes the subject matter of any of Examples 51-87, and further including determining, by the compute device, the predicted price of the recurrence of the recurring transaction.

Example 89 includes the subject matter of any of Examples 51-88, and wherein determining the predicted price comprises determining the predicted price as a function of a dominant amount representing an amount that has occurred a threshold number of times within a predefined time period.

Example 90 includes the subject matter of any of Examples 51-89, and wherein determining the predicted price comprises determining the predicted price as a function of interquartile ranges.

Example 91 includes the subject matter of any of Examples 51-90, and further including presenting, by the compute device, the recurring transaction in a web-based user interface or a user interface of a software application.

Example 92 includes the subject matter of any of Examples 51-91, and further including presenting the recurring transaction in a calendar view.

Example 93 includes the subject matter of any of Examples 51-92, and further including presenting, by the compute device, a warning based on a current account balance and a predicted amount of recurring transactions for a remainder of a defined time period.

Example 94 includes the subject matter of any of Examples 51-93, and further including presenting, by the compute device, a predicted remaining account balance after payment of the predicted amount.

Example 95 includes the subject matter of any of Examples 51-94, and further including presenting, by the compute device, a summary of aggregate recurring transactions over a defined time period.

Example 96 includes the subject matter of any of Examples 51-95, and further including obtaining, by the compute device, feedback from one or more customers.

Example 97 includes the subject matter of any of Examples 51-96, and further including aggregating, by the compute device, feedback from multiple customers.

Example 98 includes the subject matter of any of Examples 51-97, and further including obtaining, by the compute device, feedback identifying a previously unidentified recurring transaction or obtaining feedback identifying a transaction as a non-recurring transaction.

Example 99 includes the subject matter of any of Examples 51-98, and further including obtaining, by the compute device, feedback designating multiple different payee identifiers as the same payee.

Example 100 includes the subject matter of any of Examples 51-99, and further including obtaining, by the compute device, data defining an end date for a recurring transaction.

Example 101 includes one or more machine-readable storage media comprising a plurality of instructions stored thereon that, in response to being executed, cause a compute device to obtain data indicative of financial transactions associated with one or more customer accounts with a financial institution; perform at least one data transformation operation on descriptions of the financial transactions in the obtained data to enable identification of recurring transactions, including grouping the financial transactions based on a similarity of the descriptions; combine determinations from multiple analysis algorithms executed on a group of the financial transactions to obtain a confidence score indicative of whether the group of transactions represents a recurring transaction; and present, in response to a determination that the confidence score indicates that the group of financial transactions represents a recurring transaction, a predicted amount and date for a recurrence of the recurring transaction.

Example 102 includes the subject matter of Example 101, and wherein to obtain data indicative of financial transactions comprises to obtain data indicative of debit card purchases.

Example 103 includes the subject matter of any of Examples 101 and 102, and wherein to obtain data indicative of financial transactions comprises to obtain data indicative of automated clearing house transactions.

Example 104 includes the subject matter of any of Examples 101-103, and wherein to obtain data indicative of financial transactions comprises to obtain data indicative of bill payments.

Example 105 includes the subject matter of any of Examples 101-104, and wherein to obtain data indicative of financial transactions comprises to obtain data indicative of wire transfers.

Example 106 includes the subject matter of any of Examples 101-105, and wherein to obtain data indicative of financial transactions comprises to exclude data indicative of transactions occurring more than a predefined number of times in a predefined time period.

Example 107 includes the subject matter of any of Examples 101-106, and wherein to exclude data indicative of transactions occurring more than a predefined number of times in a predefined time period comprises to exclude data indicative of transactions occurring more than 52 times in a year.

Example 108 includes the subject matter of any of Examples 101-107, and wherein to perform at least one data transformation operation comprises to convert the descriptions to uppercase.

Example 109 includes the subject matter of any of Examples 101-108, and wherein to perform at least one data transformation operation comprises to remove noise in the descriptions of the financial transactions.

Example 110 includes the subject matter of any of Examples 101-109, and wherein to remove noise comprises to remove digit and letter combinations.

Example 111 includes the subject matter of any of Examples 101-110, and wherein to remove noise comprises to remove one or more symbols.

Example 112 includes the subject matter of any of Examples 101-111, and wherein to remove noise comprises to remove month abbreviations.

Example 113 includes the subject matter of any of Examples 101-112, and wherein to remove noise comprises to expand predefined abbreviations into corresponding words.

Example 114 includes the subject matter of any of Examples 101-113, and wherein to remove noise comprises to remove repeated spaces.

Example 115 includes the subject matter of any of Examples 101-114, and wherein to perform at least one data transformation operation comprises to preserve or reinsert an alphanumeric sequence that satisfies a repetition threshold.

Example 116 includes the subject matter of any of Examples 101-115, and wherein the instructions additionally cause the compute device to group financial transactions based additionally on a corresponding customer account associated with each financial transaction.

Example 117 includes the subject matter of any of Examples 101-116, and wherein to perform at least one data transformation operation comprises to determine transaction dates from the descriptions.

Example 118 includes the subject matter of any of Examples 101-117, and wherein to determine transaction dates from the descriptions comprises to determine transaction dates by matching the descriptions to a set of predefined date encoding patterns.

Example 119 includes the subject matter of any of Examples 101-118, and wherein to combine determinations from multiple analysis algorithms comprises determining an identification score.

Example 120 includes the subject matter of any of Examples 101-119, and wherein to determine an identification score comprises to determine the identification score as a function of frequency types and frequency methods.

Example 121 includes the subject matter of any of Examples 101-120, and wherein to combine determinations from multiple analysis algorithms comprises to determine a consistency score.

Example 122 includes the subject matter of any of Examples 101-121, and wherein to determine the consistency score comprises to determine the consistency score as a function of frequency types and frequency methods.

Example 123 includes the subject matter of any of Examples 101-122, and wherein to combine determinations from multiple analysis algorithms comprises to determine a median days between transactions score.

Example 124 includes the subject matter of any of Examples 101-123, and wherein to combine determinations from multiple analysis algorithms comprises to determine at least one of an average days between transactions score or a weeks between transactions score.

Example 125 includes the subject matter of any of Examples 101-124, and wherein to combine determinations from multiple analysis algorithms comprises to determine a standard deviation of days between transactions score.

Example 126 includes the subject matter of any of Examples 101-125, and wherein to combine determinations from multiple analysis algorithms comprises to determine a standard deviation of day of week score.

Example 127 includes the subject matter of any of Examples 101-126, and wherein to combine determinations from multiple analysis algorithms comprises to determine a standard deviation of day of month score.

Example 128 includes the subject matter of any of Examples 101-127, and wherein to combine determinations from multiple analysis algorithms comprises to determine a standard deviation of amount score.

Example 129 includes the subject matter of any of Examples 101-128, and wherein to combine determinations from multiple analysis algorithms comprises to determine a dominant amount score.

Example 130 includes the subject matter of any of Examples 101-129, and wherein to combine determinations from multiple analysis algorithms comprises to determine an automated clearing house and payroll score.

Example 131 includes the subject matter of any of Examples 101-130, and wherein the instructions additionally cause the compute device to compare the confidence score to a threshold score to determine whether the group of financial transactions represent a recurring transaction.

Example 132 includes the subject matter of any of Examples 101-131, and wherein the instructions additionally cause the compute device to perform a recurring transaction recognition operation based on feedback from a consumer indicating that transactions previously identified as recurring transactions are not recurring transactions or that transactions previously not identified as recurring transactions are recurring transactions.

Example 133 includes the subject matter of any of Examples 101-132, and wherein the instructions additionally cause the compute device to determine a predicted date for the recurrence of the recurring transaction as a function of a dominant interval indicative of a mode of days between financial transactions associated with the recurring transaction.

Example 134 includes the subject matter of any of Examples 101-133, and wherein the instructions additionally cause the compute device to determine a predicted date range for the recurrence of the recurring transaction.

Example 135 includes the subject matter of any of Examples 101-134, and wherein the instructions additionally cause the compute device to determine, in response to a determination that no dominant interval is present, a predicted date for the recurrence of the recurring transaction as a function of a frequency type associated with the recurring transaction.

Example 136 includes the subject matter of any of Examples 101-135, and wherein to determine the predicted date as a function of a frequency type comprises to determine the predicted date as a function of a priority ranking of the frequency types.

Example 137 includes the subject matter of any of Examples 101-136, and wherein to determine the predicted date as a function of the frequency type comprises to determine a predicted date range for the recurrence.

Example 138 includes the subject matter of any of Examples 101-137, and wherein the instructions additionally cause the compute device to determine the predicted price of the recurrence of the recurring transaction.

Example 139 includes the subject matter of any of Examples 101-138, and wherein to determine the predicted price comprises to determine the predicted price as a function of a dominant amount representing an amount that has occurred a threshold number of times within a predefined time period.

Example 140 includes the subject matter of any of Examples 101-139, and wherein to determine the predicted price comprises to determine the predicted price as a function of interquartile ranges.

Example 141 includes the subject matter of any of Examples 101-140, and wherein the instructions additionally cause the compute device to present the recurring transaction in a web-based user interface or a user interface of a software application.

Example 142 includes the subject matter of any of Examples 101-141, and wherein the instructions additionally cause the compute device to present the recurring transaction in a calendar view.

Example 143 includes the subject matter of any of Examples 101-142, and wherein the instructions additionally cause the compute device to present a warning based on a current account balance and a predicted amount of recurring transactions for a remainder of a defined time period.

Example 144 includes the subject matter of any of Examples 101-143, and wherein the instructions additionally cause the compute device to present a predicted remaining account balance after payment of the predicted amount.

Example 145 includes the subject matter of any of Examples 101-144, and wherein the instructions additionally cause the compute device to present a summary of aggregate recurring transactions over a defined time period.

Example 146 includes the subject matter of any of Examples 101-145, and wherein the instructions additionally cause the compute device to obtain feedback from one or more customers.

Example 147 includes the subject matter of any of Examples 101-146, and wherein the instructions additionally cause the compute device to aggregate feedback from multiple customers.

Example 148 includes the subject matter of any of Examples 101-147, and wherein the instructions additionally cause the compute device to obtain feedback identifying a previously unidentified recurring transaction or obtain feedback identifying a transaction as a non-recurring transaction.

Example 149 includes the subject matter of any of Examples 101-148, and wherein the instructions additionally cause the compute device to obtain feedback designating multiple different payee identifiers as the same payee.

Example 150 includes the subject matter of any of Examples 101-149, and wherein the instructions additionally cause the compute device to obtain data defining an end date for a recurring transaction.

1. A compute device comprising:
circuitry configured to:
obtain data indicative of financial transactions associated with one or more customer accounts with a financial institution;
perform at least one data transformation operation on descriptions of the financial transactions in the obtained data to enable identification of recurring transactions, including grouping the financial transactions based on a similarity of the descriptions;
combine determinations from multiple analysis algorithms executed on a group of the financial transactions to obtain a confidence score indicative of whether the group of transactions represents a recurring transaction; and
present, in response to a determination that the confidence score indicates that the group of financial transactions represents a recurring transaction, a predicted amount and date for a recurrence of the recurring transaction.

2. The compute device of claim 1, wherein to obtain data indicative of financial transactions comprises to exclude data indicative of transactions occurring more than a predefined number of times in a predefined time period.

3. The compute device of claim 2, wherein to exclude data indicative of transactions occurring more than a predefined number of times in a predefined time period comprises to exclude data indicative of transactions occurring more than 52 times in a year.

4. The compute device of claim 1, wherein to perform at least one data transformation operation comprises one or more of (i) to convert the descriptions to uppercase; and/or to remove noise in the descriptions of the financial transactions.

5. The compute device of claim 4, wherein to remove noise comprises: (i) to remove digit and letter combinations; (ii) to remove one or more symbols; (iii) to remove month abbreviations; (iv) to expand predefined abbreviations into corresponding words; and/or (v) to remove repeated spaces.

6. The compute device of claim 1, wherein to perform at least one data transformation operation comprises to preserve or reinsert an alphanumeric sequence that satisfies a repetition threshold.

7. The compute device of claim 1, wherein the circuitry is configured to group financial transactions based additionally on a corresponding customer account associated with each financial transaction, wherein to perform at least one data transformation operation comprises to determine transaction dates from the descriptions.

8. The compute device of claim 7, wherein to determine transaction dates from the descriptions comprises to determine transaction dates by matching the descriptions to a set of predefined date encoding patterns.

9. The compute device of claim 1, wherein to combine determinations from multiple analysis algorithms comprises one or more of: (i) to determine an identification score, wherein to determine an identification score comprises to determine the identification score as a function of frequency types and frequency methods; (ii) to determine a median days between transactions score; (iii) to determine at least one of an average days between transactions score or a weeks between transactions score; (iv) to determine a standard deviation of days between transactions score; (v) to determine a standard deviation of day of week score; (vi) to determine a standard deviation of day of month score; (vii) to determine a standard deviation of amount score; (viii) to determine a dominant amount score; (ix) to determine an automated clearing house and payroll score.

10. The compute device of claim 1, wherein the circuitry is further configured to compare the confidence score to a threshold score to determine whether the group of financial transactions represent a recurring transaction.

11. The compute device of claim 1, wherein the circuitry is further configured to perform a recurring transaction recognition operation based on feedback from a consumer indicating that transactions previously identified as recurring transactions are not recurring transactions or that transactions previously not identified as recurring transactions are recurring transactions.

12. The compute device of claim 1, wherein the circuitry is further configured to determine a predicted date for the recurrence of the recurring transaction as a function of a dominant interval indicative of a mode of days between financial transactions associated with the recurring transaction.

13. The compute device of claim 12, wherein the circuitry is further configured to determine a predicted date range for the recurrence of the recurring transaction.

14. The compute device of claim 1, wherein the circuitry is further configured to determine, in response to a determination that no dominant interval is present, a predicted date for the recurrence of the recurring transaction as a function of a frequency type associated with the recurring transaction.

15. The compute device of claim 14, wherein to determine the predicted date as a function of a frequency type comprises one or more of: (i) to determine the predicted date as a function of a priority ranking of the frequency types; or (ii) to determine the predicted date as a function of the frequency type comprises to determine a predicted date range for the recurrence.

16. The compute device of claim 1, wherein the circuitry is further configured to determine the predicted price of the recurrence of the recurring transaction, wherein to determine the predicted price comprises one or more of: (i) to determine the predicted price as a function of a dominant amount representing an amount that has occurred a threshold number of times within a predefined time period; or (ii) to determine the predicted price as a function of interquartile ranges.

17. The compute device of claim 1, wherein the circuitry is further configured to present a warning based on a current account balance and a predicted amount of recurring transactions for a remainder of a defined time period.

18. The compute device of claim 17, wherein the circuitry is further configured to present a predicted remaining account balance after payment of the predicted amount.

19. The compute device of claim 1, wherein the circuitry is further configured to present a summary of aggregate recurring transactions over a defined time period.

20. A method comprising:
obtaining, by a compute device, data indicative of financial transactions associated with one or more customer accounts with a financial institution;
performing, by the compute device, at least one data transformation operation on descriptions of the financial transactions in the obtained data to enable identification of recurring transactions, including grouping the financial transactions based on a similarity of the descriptions;
combining, by the compute device, determinations from multiple analysis algorithms executed on a group of the financial transactions to obtain a confidence score indicative of whether the group of transactions represents a recurring transaction; and
presenting, by the compute device and in response to a determination that the confidence score indicates that the group of financial transactions represents a recurring transaction, a predicted amount and date for a recurrence of the recurring transaction.
